(19) United States
(12) Patent Application Publication
(10) Pub. No.: US 2004/0093885 A1
(43) Pub. Date: May 20, 2004

(54) Vehicle air conditioner with main blower and sub-blower

(76) Inventors: Koji Ito, Nagoya-city (JP); Yoshihiko Okumura, Kariya-city (JP); Takahiro Tokunaga, Kosai-city (JP); Noriyoshi Miyajima, Nukata-gun (JP)

Correspondence Address: HARNESS, DICKEY & PIERCE, P.L.C., P.O. BOX 828, BLOOMFIELD HILLS, MI, 48303, US

(21) Appl. No.: 10/705,527

(22) Filed: Nov. 10, 2003

(30) Foreign Application Priority Data
Nov. 11, 2002 (JP) 2002-326868
Nov. 11, 2002 (JP) 2002-326870

(51) Int. Cl. B60H 3/00; B61D 27/00; F25B 41/04; B60H 1/32

(52) U.S. Cl. 62/244; 165/42; 62/204

(57) ABSTRACT

A vehicle air conditioner includes a main blower and a sub-blower for blowing air into a passenger compartment. A heat exchange unit for performing a heat exchange with air blown by the main blower is disposed in a case, and the case is provided with a front air passage and a rear air passage. A rear air duct through which air in the rear air passage is introduced to a rear area in the passenger compartment is connected to the case, so that an air flow resistance in the rear air passage becomes larger as compared with the air flow resistance in the front air passage. Further, the sub-blower is disposed integrally with the case for blowing air in the rear air passage to the rear area in the passenger compartment. Accordingly, it can effectively prevent a shortage of an air conditioning capacity in the rear area of the passenger compartment.

### CROSS REFERENCE TO RELATED APPLICATION

This application is based on Japanese Patent Applications No. 2002-326868 filed on Nov. 11, 2002 and No. 2002-326870 filed on Nov. 11, 2002, the disclosure of which is incorporated herein by reference.

### BACKGROUND OF THE INVENTION

1. Field of the Invention

The present invention relates to a vehicle air conditioner having a main blower and a sub-blower, which can perform air-conditioning of a plurality of different areas in a passenger compartment by using a single air conditioning unit.

2. Related Art

There have been proposed various kinds of vehicle air conditioners each of which performs air-conditioning of a plurality of different areas, specifically, a front seat area and a rear seat area in a passenger compartment by using a single air conditioning unit. For example, in a vehicle air conditioner disclosed in JP-A-11-235914, a front air conditioning unit for air-conditioning a front seat area of the passenger compartment is provided with an additional function for blowing off conditioned air also to a rear seat area of the passenger compartment. The front air conditioning unit is usually arranged in an instrument panel (i.e., dashboard) on the front in the passenger compartment. Therefore, it is necessary to connect a rear air opening of the front air conditioning unit and a rear air outlet port arranged in the rear area in the passenger compartment by using a long rear air duct so as to blow off conditioned air to the rear seat area. As a result, air flow resistance (i.e., resistance to air flow) in a rear air passage becomes extremely large as compared with air flow resistance in a front air passage. Thus, if conditioned air is sent to both of the front air passage and the rear air passage by using a single blower of the front air conditioning unit, the volume of air blown off to the rear seat area becomes extremely small.

It is thought to take measures of increasing the ratio of volume of air blown off to the rear seat area by increasing air flow resistance (pressure loss) in the front air passage of the front air conditioning unit and enhancing a blower capacity (output power of a driving motor). In this case, however, not only the power consumption of the blower but also operation noises of a motor increase, and further air blowing noises also increase with an increase of air blowing pressure. Thus, these measures are impractical.

Alternatively, it is thought to reduce the air flow resistance in the rear air passage by increasing the size of the rear air duct. However, when the size of the rear air duct increases it difficult to mount the air conditioning unit in a limited space in a passenger compartment floor and the like, thereby deteriorating mounting performance of the air conditioner in the vehicle.

The above-described technique of the related art has been described in a case where the front seat area and the rear seat area in the passenger compartment are air-conditioned by using the single front air conditioning unit. However, there is the same problem also in a case where a front area and a passenger's seat in the passenger compartment are air-conditioned by using the single front air conditioning unit, because air flow resistance in a seat-side air passage becomes extremely large as compared with the air flow resistance in the front air passage.

### SUMMARY OF THE INVENTION

In view of the above-described problems, it is an object of the present invention to provide a vehicle air conditioner having a first air passage for flowing conditioned air toward a first area in a passenger compartment and a second air passage for flowing conditioned air toward a second area in the passenger compartment in an air conditioning case where a heat exchange unit is disposed, so that air flow resistance in the second air passage is higher than air flow resistance in the first air passage. In the air conditioner, it can prevent a shortage of air-conditioning capacity in the second area of the passenger compartment.

According to the present invention, a vehicle air conditioner includes a main blower for blowing air, a heat exchange unit for performing heat exchange with air blown by the main blower, and a case for accommodating the heat exchange unit. The case has a first passage through which conditioned air after being heat-exchanged with the heat exchange unit flows toward a first area in the passenger compartment, and a second passage through which conditioned air after being heat-exchanged in the heat exchange unit flows toward a second area in the passenger compartment. Further, a connection duct through which conditioned air in the second passage is introduced to the second area of the passenger compartment is connected to the second passage such that an air flow resistance in the second passage becomes larger than an air flow resistance in the first passage. In the air conditioner, a sub-blower is disposed integrally with the case, so as to blow conditioned air in the second passage toward the second area of the passenger compartment. Therefore, a pressure of air to be blown to the second area of the passenger compartment can be increased by the sub-blower. Thus, by suitably selecting a blowing capacity of the sub-blower, an air amount to be blown to the second area of the passenger compartment can be suitably increased relative to an air amount to be blown to the first area of the passenger compartment.

As a result, it can prevent a shortage of the air conditioning capacity in the second area of the passenger compartment without increasing the capacity of the main blower. Therefore, it also prevents an air blowing noise of the main blower from being increased. Further, in this case, because it is unnecessary to increase the passage area of a duct for the second area, the mounting performance of the air conditioner in the vehicle can be improved.

Specifically, the heat exchange unit includes at least a heating heat exchanger for heating air, and the second passage includes a hot air passage through which air after passing through the heating heat exchanger flows, and a cold air passage through which air bypassing the heating heat exchanger flows. A temperature adjustment unit is disposed to adjust an air amount flowing through the hot air passage and an air amount flowing through the cold air passage to adjust a temperature of the conditioned air to be blown to the second area in the passenger compartment, and the sub-blower is disposed downstream of the temperature adjustment unit. Therefore, hot air from the hot air passage and cold air from the cold air passage can be effectively mixed by the operation of the sub-blower, so that conditioned air having a target temperature, substantially without a temperature difference, can be blown to the second area of the passenger compartment by the sub-blower.

For example, the first area is a front seat area in the passenger compartment, the first air passage is a front air passage through which air flows toward the front seat area, the second area is a rear seat area in the passenger compartment, and the second air passage is a rear air passage through which air flows toward the rear seat area. In this case, a front temperature adjustment unit is disposed to adjust a temperature of air blown from the front air passage, and a rear temperature adjustment unit is disposed to adjust a flow ratio between hot air after passing through the heating heat exchanger and cold air bypassing the heating heat exchanger, in the rear air passage, and the sub-blower is disposed at a downstream side of the rear temperature adjustment unit in the rear air passage. Therefore, the temperature and the amount of air to be blown into the rear seat area of the passenger compartment can be controlled independently from the temperature and the amount of air to be blown to the front seat area in the passenger compartment.

More specifically, the rear air passage includes a rear hot air passage through which air after passing through the heating heat exchanger flows, and a rear cold air passage through which air bypassing the heating heat exchanger flows. Further, the rear temperature adjustment unit includes a rear hot air door for adjusting a passage area of the rear hot air passage, and a rear cold air door for adjusting a passage area of the rear cold air passage. In this case, when a maximum heating state of the rear seat area is set, the rear hot air door fully opens the rear hot air passage, and the rear cold air door fully closes the rear cold air passage. When a maximum cooling state of the rear seat area is set, the rear hot air door fully closes the rear hot air passage, and the rear cold air door fully opens the rear cold air passage. Further, in a temperature adjustment state of the rear seat area between the maximum heating state and the maximum cooling state, one of the rear hot air door and the rear cold air door is operated to increase the passage area, and the other one of the rear hot air door and the rear cold air door is operated to decrease the passage area. Thus, linear control characteristics of variations in passage areas of the rear hot air passage and the rear cold air passage can be improved, and a linear temperature control characteristic of air blown toward the rear seat area of the passenger compartment can be improved. Further, it is possible to set a rear shut state where the rear hot air door fully closes the rear hot air passage and the rear cold air door fully closes the rear cold air passage.

For example, the rear hot air door and the rear cold air door are arranged at a side of a suction port of the sub-blower in an axial direction of the sub-blower. Therefore, arrangement spaces of the rear hot air door and the rear cold air door can be effectively provided. Further, when each of the rear hot air door and the rear cold air door is a plate door rotatable in a rotation space, the rear hot air door and the rear cold air door are disposed such that its rotation spaces are positioned at an inner peripheral side of the suction port.

Preferably, the case further has therein a seat cold air passage into which air branched from the rear cold air passage flows, and a seat hot air passage into which air after passing through the heating heat exchanger flows. In this case, a seat temperature adjustment unit is disposed for adjusting a flow ratio between air from the seat hot air passage and air from the seat cold air passage to adjust a temperature of conditioned air to be blown into a seat in the passenger compartment. Therefore, the temperature of air to be blown into the seat of the passenger compartment can be independently controlled.

Preferably, the rear air passage is branched downstream of the sub-blower, into a rear face passage through which air is blown toward a rear upper side in the rear seat area of the passenger compartment, and a rear foot passage through which air is blown toward a rear lower side in the rear seat area of the passenger compartment. In addition, the rear air passage includes a rear bypass passage through which a part of air at an upstream portion upstream from the rear temperature adjustment unit is directly introduced into any one of rear face passage and the rear foot passage. In this case, a bi-level mode can be effectively set. For example, the rear bypass passage is a rear cold air bypass passage through which a part of cold air in the rear cold air passage at the upstream portion of the rear temperature adjustment unit is directly introduced to the rear face passage. Alternately, the rear bypass passage is a rear hot air bypass passage through which a part of hot air in the rear hot air passage at the upstream portion of the rear temperature adjustment unit is directly introduced to the rear foot passage. Accordingly, a temperature difference between air to be blown to a rear upper side of the passenger compartment and air to be blown to a rear lower side of the passenger compartment can be readily set.

### BRIEF DESCRIPTION OF THE DRAWINGS

Other objects, features and advantages of the present invention will become more apparent from the following detailed description made with reference to the accompanying drawings, in which:

FIG. 1 is a schematic cross-sectional view showing an interior air conditioning device of a vehicle air conditioner in accordance with a first embodiment of the present invention;

FIG. 2 is a schematic cross-sectional view showing a sub-blower of the interior air conditioning device in FIG. 1;

FIG. 3 is a schematic cross-sectional view of a heat exchange unit and a sub-blower of an interior air conditioning device in accordance with a second embodiment of the present invention;

FIG. 4 is a schematic cross-sectional view showing a heat exchange unit and a sub-blower of an interior air conditioning device in accordance with a third embodiment of the present invention;

FIG. 5 is a schematic front view showing the heat exchange unit and the sub-blower of the interior air conditioning device in accordance with the third embodiment;

FIG. 6 is a schematic cross-sectional view showing a heat exchange unit and a sub blower of an interior air conditioning device in accordance with a fourth embodiment of the present invention;

FIG. 7 is a schematic cross-sectional view of a blower unit of the interior air conditioning device in accordance with the fourth embodiment;

FIG. 8 is a cross-sectional view taken on the line VIII-VIII in FIG. 6;

FIG. 9 is a cross-sectional view taken on the line IX-IX in FIG. 6;

FIG. 10 is a control characteristic graph showing the relationship between a rear air temperature to be blown to a rear seat area of a passenger compartment and a rear door opening degree, for explaining the operation effect by the fourth embodiment;

FIG. 11 is a schematic cross-sectional view of a heat exchange unit and a sub-blower of an interior air conditioning device in accordance with a fifth embodiment of the present invention;

FIG. 12 is a control characteristic graph the relationship between a door opening degree and a ratio of a rear passage area to a maximum air passage area in the fifth embodiment;

FIG. 13 is a schematic cross-sectional view showing a heat exchange unit and a sub-blower of an interior air conditioning device in accordance with a sixth embodiment of the present invention;

FIG. 14 is a cross-sectional view taken on the line XIV-XIV in FIG. 13; and

FIG. 15 is a schematic cross-sectional view of a heat exchange unit and a sub-blower of an interior air conditioning device in accordance with a seventh embodiment of the present invention.

### DETAILED DESCRIPTION OF THE PREFERED EMBODIMENTS

(First Embodiment)

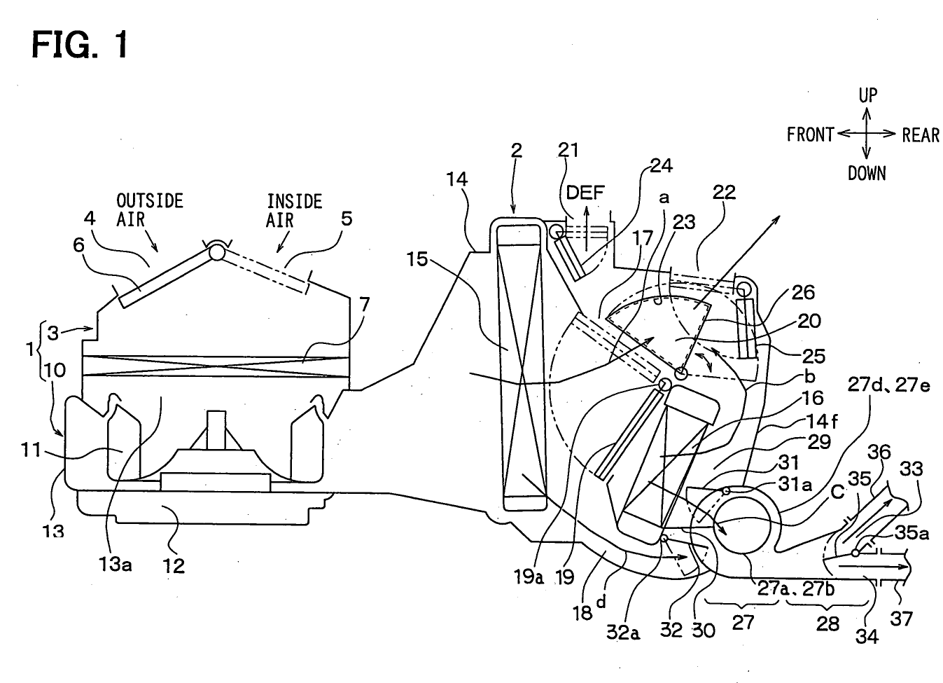

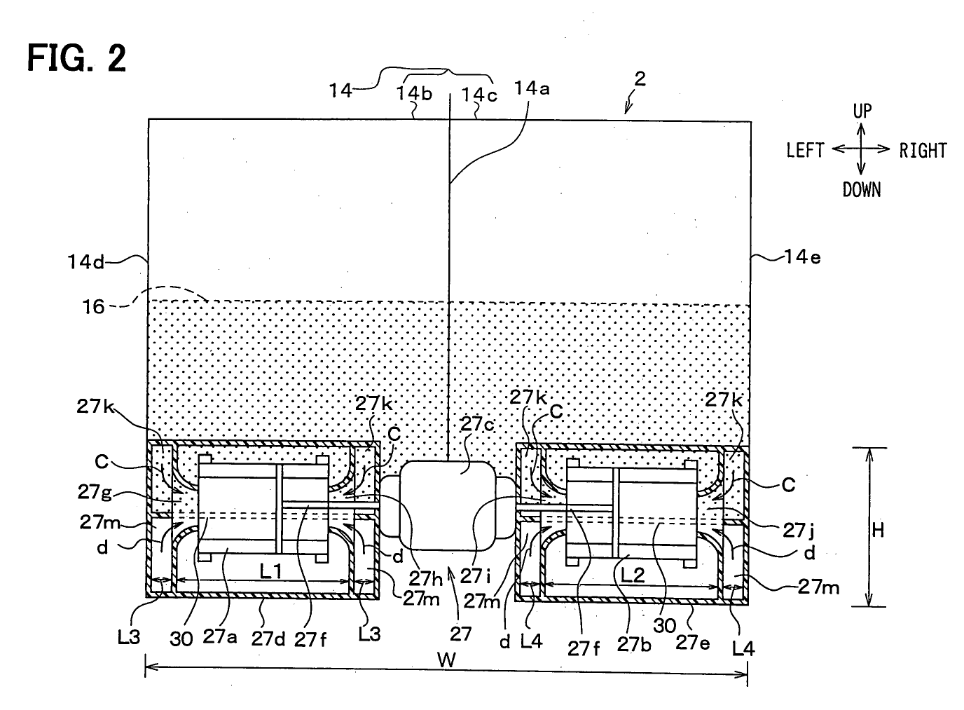

An interior air conditioning device shown in FIG. 1 is broadly constructed of a blower unit 1 and a heat exchange unit 2. In FIG. 1 and FIG. 2, arrows showing “up and down”, “front and rear”, and “left and right” indicate directions in a state where the heat exchange unit 2 is mounted in a vehicle, respectively. In FIG. 1, for convenience of preparing a drawing, the blower unit 1 is arranged on the front side of the vehicle of the heat exchange unit 2, but in reality, the blower unit 1 is arranged at an offset position in the lateral direction of the vehicle of the heat exchange unit 2. That is, the heat exchange unit 2 is arranged nearly at the center in the lateral direction of the vehicle inside an instrument panel (i.e., dashboard) in the passenger compartment. The blower unit 1 is arranged to be offset to a front passenger's seat side from the position of the heat exchange unit 2 in the lateral direction of the vehicle.

The blower unit 1 has an inside/outside air switching box 3 at the upper portion thereof. This inside/outside air switching box 3 has an outside air introduction port 4, an inside air introduction port 5, and an inside/outside air switching door 6. The inside/outside air switching door 6 opens and closes the outside air introduction port 4 and the inside air introduction port 5 to selectively introduce outside air (i.e., air outside the passenger compartment) and inside air (i.e., air inside the passenger compartment). The inside/outside air switching door 6 is connected to and turned by an inside/outside air switching mechanism (not shown). This inside/outside air switching mechanism is constructed of an actuator mechanism using a servomotor. Then, a filter 7 for removing dust, bad smell and the like in air introduced into the inside/outside air switching box 3 is arranged at the lower side of the inside/outside air switching box 3. Therefore, air introduced into the inside/outside air switching box 3 is cleaned by the filter 7.

A main blower 10 is arranged below the filter 7 in the blower unit 1. This main blower 10 has a blower fan 11 made of a centrifugal fan having many blades arranged in an annular shape, a motor 12 for rotating the blower fan 11, and a spiral scroll case 13 for receiving the blower fan 11. A suction port 13a from which air from the filter 7 is sucked is shaped like a bell mouth. The suction port 13a is formed in the top portion of the scroll case 13.

Next, the heat exchange unit 2 will be described. The heat exchange unit 2 has a case 14 made of resin. The case 14, as shown in FIG. 2, is constructed by combining two division cases 14b, 14c that are molded in such a manner as to divide the case 14 into two left and right parts at a division plane 14a located at the center in the lateral direction of the vehicle. The left and right parts are fastened by a fastening member (not shown) such as a suitable clamp to be integrated. The air outlet of the scroll case 13 is connected to an opening on a front part of the case 14. Thus, air flows into the front part of the case 14 by operating the blower fan 11 in the blower unit 1.

Air blown by the blower unit 1 flows through the case 14 from the front side of the vehicle to the rear side of the vehicle. An evaporator 15 and a heater core 16 are arranged in series in order from the upstream side of air flow in the case 14. The evaporator 15 constructs a well-known refrigeration cycle together with a compressor, a condenser and a pressure reducing unit (all of which are not shown). The evaporator 15 is a cooling heat exchanger for cooling air in the case 14. The evaporator 15 has a heat exchange core part constructed of flat tubes through which a low-pressure refrigerant having decompressed by a pressure reducing unit flows and corrugated fins connected to the flat tubes.

The heater core 16 is a heating heat exchanger for heating air in the case 14 by using hot water (engine cooling water) flowing therethrough as a heat source. The heater core 16 has a heat exchange core part constructed of flat tubes through which the hot water flows and corrugated fins connected to the flat tubes. Here, in FIG. 2, a finely dotted area shows an area where the heater core 16 is arranged.

In the case 14, a front cold air passage 17 is formed above the heater core 16 and a rear cold air passage 18 is formed below the heater core 16. Cold air after passing through the evaporator 15 bypasses the heater core 16 while passing through these cold air passages 17, 18.

A front air mixing door 19 is disposed between the evaporator 15 and the heater core 16 in the case 14. The front air mixing door 19 is constructed of a plate door that is rotated around a rotary shaft 19a arranged near the top end of the heater core 16. The front air mixing door 19 adjusts the ratio of cold air “a” passing through the front cold air passage 17 and hot air “b” passing through the heater core 16 and hence adjusts the temperature of air to be blown a front area in the passenger compartment. That is, a front seat area temperature adjusting unit is constructed with the front air mixing door 19.

The rotary shaft 19a of the front air mixing door 19 is connected to and is rotated by a front area temperature adjusting mechanism (not shown). The front area temperature adjusting mechanism is constructed of an actuator mechanism using a servomotor.

In order to ensure a space in which the front air mixing door 19 is turned, the heater core 16 is arranged in such a manner that its top end is slanted to the rear side of the vehicle as compared with its bottom end. Then, a front air mixing portion 20 for mixing the cold air “a” and the hot air “b” is formed above the heater core 16 in the case 14.

A plurality of front air outlet openings 21, 22, 23 are arranged in the upper rear portion of the case 14. Conditioned air from the front air mixing portion 20 flows into these front air outlet openings 21, 22, 23. A defroster opening 21 among these front air outlet openings 21, 22, 23 is open at the top surface of the case 14 and communicates with a defroster air outlet port (not shown) for blowing off the conditioned air toward the inside surface of a windshield glass through a defroster duct (not shown). The defroster opening 21 is opened or closed by a defroster door 24.

A front face opening 22 is open at a vehicle rear side of the defroster opening 21 in the top surface of the case 14. The front face opening 22 communicates with a front face air outlet port (not shown) for blowing off the conditioned air toward the upper half body of a passenger on the front seat through a front face duct (not shown). Then, the front face opening 22 is opened or closed by a front face door 25.

Front foot openings 23 are open at portions on the left and right sides of the front air mixing portion 20 of the left and right side walls 14d, 14e of the case 14 (see FIG. 2). The left and right front foot openings 23 communicate with left and right front foot air outlet ports (not shown) for blowing off the conditioned air toward the feet of the passenger on the front seat through a front foot duct (not shown). These left and right front foot openings 23 are opened or closed by the left and right front foot doors 26.

Each of these front foot openings 23 and front foot doors 26 is approximately shaped like a fan in this embodiment. The left and right fan-shaped foot doors 26 are turned along left and right side walls 14d, 14e of the case 14, thereby opening and closing the front foot openings 23. The position of the front door 26 shown by the solid line in FIG. 1 shows a state where the front foot door opening 23 is fully closed.

The above-described doors 24, 25, 26 construct front air outlet mode doors for switching front air outlet modes, and are connected to and operated in association with each other by a common front air outlet mode operating mechanism via a link mechanism (not shown). The front air outlet mode operating mechanism is constructed of an actuator mechanism using a servomotor.

A rear sub-blower 27 is arranged at a portion separated by a predetermined distance from the bottom portion of the heater core 16 to the downstream side of air flow (to the rear side of the vehicle) in the lower portion in the case 14. The rear sub-blower 27, as shown in FIG. 2, has two blower fans 27a, 27b, a driving motor 27c for driving the two blower fans 27a, 27b, and spiral scroll cases 27d, 27e for receiving the blower fans 27a, 27b. Each of the blower fans 27a, 27b is constructed of a centrifugal fan having many blades arranged in an annular shape. Here, in FIG. 2, a reference symbol H designates the height of the sub-blower 27 and W designates the width (i.e., the dimension in the lateral direction of the vehicle) of the sub-blower 27.

The left and right scroll cases 27d, 27e are formed from a resin integrally with left and right division cases 14b, 14c, respectively. Then, rear air ducts 28 (FIG. 1) are arranged on the downstream sides (rear side of the vehicle) of the left and right scroll cases 27d, 27e. The rear air ducts 28 are provided in such a manner as to join airs blown off from the outlets of the scroll cases 27d, 27e and to guide them toward the rear side of the vehicle. The rear air ducts 28 are also formed integrally with the left and right division cases 14b, 14c together with the scroll cases 27d, 27e.

A driving motor 27c of the sub-blower 27 is constructed of a double shaft type in which its rotary shaft 27f protrudes to both sides in an axial direction and is arranged at the center in the lateral direction of the vehicle with respect to the case 14. Then, the driving motor 27c is arranged in such a manner that its rotary shaft 27f faces in the left and right direction of the vehicle, outside the rear wall surface 14f of the vehicle of the case 14, and is fixed to the scroll cases 27d, 27e.

The blower fans 27a, 27b are arranged on the left and right sides of the driving motor 27c, and the left and right blower fans 27a, 27b are connected to the left and right rotary shafts 27f, respectively. Suction ports 27g to 27j, each shaped like a bell mouth, are formed on the left and right sides of the left scroll case 27d and the right scroll case 27e. That is, the two left and right blower fans 27a, 27b are constructed as double suction fans, respectively.

The above-described respective suction ports 27g to 27j suck cold air and hot air through air passages as described below. A partition wall 30 is arranged for partitioning a hot air passage 29 formed directly behind the heater core 16 and the above-described rear cold air passage 18 from each other in the up-down direction. The partition wall 30, as shown in FIG. 1, is located in the lowermost portion on a downstream air side (rear side of the vehicle) in the heat exchange core part of the heater core 16. Then, the partition wall 30, as shown in FIG. 2, is arranged across the case 14 in the lateral direction of the vehicle.

In FIG. 2, the partition wall 30 in a portion L1 between the left and right suction ports 27g, 27h of the left blower fan 27a and in a portion L2 between the left and right suction ports 27i, 27j of the right blower fan 27b is shown by the broken lines, and the partition wall 30 in portions L3 outside the left and right suction ports 27g, 27j and in portions L4 outside the left and right suction ports 27i, 27j is shown by the solid lines. The outside portions L3, L4 construct air inlet spaces. Among the air inlet spaces with the outside portions L3, L4, an upper portion above the partition wall 30 (dotted area) forms a hot air inlet space 27k through which hot air from the hot air passage 29 flows, as shown by arrow “c”.

Then, among the above-described air inlet spaces with the outside portions L3, L4, a lower portion below the partition wall 30 (hollow area) forms a cold air inlet space 27m through which cold air from the rear cold air passage 18 flows, as shown by arrow “d”,

A hot air door 31 shown in FIG. 1 is arranged at each of the above-described four hot air inlet portions 27k and a cold air door 32 shown in FIG. 1 is arranged at each of the above-described four cold air inlet portions 27m. These hot air doors 31 and cold air doors 32, in this embodiment, are constructed of plate doors rotatable about the rotary shafts 31a and 32a, respectively. By adjusting rotation angles of the hot air door 31 and the cold air door 32, the air passage areas of the hot air inlet space 27k and the cold air inlet space 27m can be adjusted.

A total of four hot air doors 31 and a total of four cold air doors 32 construct a rear temperature adjusting unit for adjusting the temperature of air blown off to the rear seat in the passenger compartment. In this embodiment, the four hot air doors 31 are connected to and operated in association with each other by a rear hot air operating mechanism (not shown) via a link mechanism (not shown). Then, the four hot cold doors 32 are also connected to and operated in association with each other by a rear cold air operating mechanism (not shown) via a link mechanism (not shown). Each of the rear hot air operating mechanism and the cold air operating mechanism is constructed of an actuator mechanism using an independent servomotor.

In this manner, each of the rear hot air operating mechanism and the rear cold air operating mechanism is constructed of an actuator mechanism using an independent servomotor. Thus, it is possible to set a rear shut state where the hot air inlet spaces 27k are fully closed by the four hot air doors 31 and where, at the same time, the cold air inlet spaces 27m are fully closed by the four cold air doors 32.

On the other hand, in a state where conditioned air is blown off toward the rear area in the passenger compartment, in order to adjust the temperature of air blown off toward the rear seat side in the passenger compartment, the rear hot air operating mechanism and the rear cold air operating mechanism are operated in an electrically associated manner. More specifically, in a maximum heating, the hot air inlet spaces 27k are fully opened by the four hot air doors 31 and the cold air inlet spaces 27m are fully closed by the four cold air doors 32. Conversely, in a maximum cooling, the hot air inlet spaces 27k are fully closed by the four hot air doors 31 and the cold air inlet spaces 27m are fully opened by the four cold air doors 32.

Then, in a middle temperature control between the maximum heating and the maximum cooling, the hot air doors 31 and the cold air doors 32 continuously change their turning positions between the maximum heating position and the maximum cooling position to adjust the air passage areas of the hot air inlet spaces 27k and the cold air inlet spaces 27m, respectively. More specifically, when the hot air doors 31 turns to a side where the hot air inlet spaces 27k are fully closed, the cold air doors 32 turns to a side where the cold air inlet spaces 27m are fully opened. In this manner, both of the doors 31, 32 adjust the air passage areas of the hot air inlet spaces 27k and the cold air inlet spaces 27m in such a manner that the air passage area of the air inlet spaces 27k is reversely changed with respect to the air passage area of the cold air inlet spaces 27k.

A tip portion (downstream end portion) on the rear side of the vehicle of the rear air duct 28 is branched to form a rear face opening 33 located on an upper side and a rear foot opening 34 located on a lower side. Then, a rear air outlet mode door 35 is arranged inside the tip portion on the rear side of the vehicle of the rear air duct 28.

The rear air outlet mode door 35, in this embodiment, is constructed of a plate door rotatable around a rotary shaft 35a, to open and close the rear face opening 33 and the rear foot opening 34. The rear air outlet mode door 35 is connected to and operated by a rear air-outlet mode operating mechanism. The rear air-outlet mode operating mechanism is constructed of an actuator mechanism using a servomotor.

A rear face duct 36 is connected to the rear face opening 33, so that conditioned air is blown off toward the upper half body of a passenger on the rear seat from a rear face air outlet port (not shown) provided at the tip portion of the rear face duct 36. Similarly, a rear foot duct 37 is connected to the rear foot opening 34, so that conditioned air is blown off toward the feet of the passenger on the rear seat from a rear foot air outlet port (not shown) provided at the tip portion of the rear foot duct 37.

Each of the rear face duct 36 and the rear foot duct 37 is shaped like a slender duct extending to the rear area in the passenger compartment, and these slender ducts 36, 37 significantly increase the air flow resistance in the rear air passage as compared with the air flow resistance in the front air passage.

Here, the operations of the above-described various operating mechanisms such as actuator mechanisms, the main blower 10 and the sub-blower 27 are controlled by a well-known air conditioning controller (not shown) using a microcomputer.

Next, the operation of this embodiment will be described. When conditioned air blows off only to the front seat area in the passenger compartment, the driving motor 12 of the main blower 10 of the blower init 1 is energized to rotate the blower fan 11. On the other hand, the supply of current to the driving motor 27c of the sub-blower 27 is stopped so that the blower fans 27a, 27b of the sub-blower 27 is stopped.

With this operation, only the main blower 10 is operated so that air blown by the main blower passes through the evaporator 15 to be cooled and dehumidified. Cold air after passing through the evaporator 15 is then branched by the front air mixing door 19 into the cold air “a” passing through the front cold air passage 17 and the hot air “b” passing through the heater core 16. For this reason, by adjusting the flow ratio of the volume of cold air “a” and the volume of hot air “b”, by changing the opening of the front air mixing door 19, the temperature of air blown off to the front seat area in the passenger compartment can be adjusted.

The cold air “a” is mixed with the hot air “b” in the air mixing portion 20 so that conditioned air having a desired temperature is obtained. The conditioned air from the air mixing portion 20 is blown to the front area in the passenger compartment from at least one of the front air outlet ports 21, 22, 23, selected by the front air outlet mode doors 24, 25, 26, so that air-conditioning of the front area in the passenger compartment is performed.

At this time, the rear shut state is set in accordance with the stop operation of the sub-blower 27. That is, a stopping state of the operation of the sub-blower 27 is determined by the air conditioning controller, and the rear hot air operating mechanism is operated by using the control output of the air conditioning controller to operate the four hot air doors 31 to the fully closed position of the hot air inlet spaces 27k. At the same time, the rear cold air operating mechanism is operated by the control output of the air conditioning controller to operate the four cold air doors 32 to the positions for totally closing the cold air inlet spaces 27m. With this operation, the rear shut state can be set so that it can prevent the conditioned air from blowing off to the rear area in the passenger compartment.

Next, when the conditioned air blows off at the same time to both of the front area and the rear area in the passenger compartment, the driving motor 12 of the main blower 10 and the driving motor 27c of the sub-blower 27 of the blower unit 1 are energized to operate the main blower 10 and the sub-blower 27 for the rear seat at the same time.

With this operation, air is blown to the front area in the passenger compartment through the same route by the main blower 10, so that conditioned air blows off to the front area in the passenger compartment from at least one of the front air outlet ports 21, 22, 23 to perform air-conditioning of the front area in the passenger compartment.

On the other hand, at the same time when the sub-blower 27 is operated by the control output of the air conditioning controller, the four hot air doors 31 are operated at the predetermined opening positions of the hot air inlet spaces 27k and the four cold air doors 32 are operated at the predetermined opening positions of the cold air inlet spaces 27m, respectively. With this operation, among hot air that passes through and is heated by the heater core 16, hot air passing through the lower side portion of the heat exchange core part of the heater core 16 passes through the hot air inlet spaces 27k, as shown by arrow “c”. Thereafter, hot air from the hot air inlet spaces 27k is sucked into the air suction ports 27g to 27j of the blower fans 27a, 27b. At the same time, cold air passing through the rear cold air passage 18 located below the heater core 16 passes through the cold air inlet spaces 27m, as shown by arrow “d”, and is sucked into the air suction ports 27g to 27j of the blower fans 27a, 27b.

The hot air and the cold air are sent outside in the radial direction of the fan by the blower fans 27a, 27b, thereby being blown off to the rear air duct 28 from the outlets of the left and right scroll cases 27d, 27e. The hot air and the cold air are mixed each other in a process where they are sucked by the blower fans 27a, 27b and are sent toward the outlets of the scroll cases 27d, 27e, so that conditioned air having a desired temperature can be obtained for the rear area of the passenger compartment.

The air passage areas of the hot air inlet spaces 27k can be continuously adjusted by the rotational positions (openings) of the rear hot air doors 32, and in association of this adjustment, the air passage areas of the cold air inlet spaces 27m can be continuously adjusted by the rotational positions (openings) of the rear cold air doors 31. Thus, the ratio of the volume of hot air sucked into the hot air inlet spaces 27k and the volume of cold air sucked into the cold air inlet spaces 27m can be arbitrarily adjusted by adjusting the turning positions (openings) of the hot air doors 31 and the cold air doors 32, so that conditioned air having a desired temperature also can be blown to the rear seat area of the passenger compartment.

The rear face opening 33 and the rear foot opening 34 are opened or closed by the rear air outlet mode doors 35 arranged in the rear air duct 28 to open only one of the openings 33, 34 or to open both of the openings 33, 34 at the same time. With this operation, conditioned air having a desired temperature passes through the rear face duct 36 or the rear foot duct 37 and blows off to the upper half body or the feet area of the passenger on the rear seat from the rear face air outlet port (not shown) or the rear foot air outlet port (not shown) so as to perform air-conditioning of the rear area in the passenger compartment.

As the rear-only sub-blower 27, a centrifugal blower having characteristics of small air volume and high pressure type can be suitably used. Further, the sub-blower 27 has a comparatively small diameter in the blower fans 27a, 27b (for example, fan diameter: about 70 mm). The height of the blower fans 27a, 27b of double-suction type sub-blower 27 is about 70 mm, for example.

On the other hand, the main blower 10 is a centrifugal blower having characteristics of low pressure loss type and the fan diameter of the blower fan 11 is sufficiently larger than the sub-blower 27 and is about 160 mm, for example. Then, the height of the blower fan 11 has a sufficiently large size about 80 mm even if the blower fan 11 is a single suction type.

According to the present invention, it is possible to increase the volume of air blown off to the rear area of the passenger compartment without increasing the capacity (output power of the driving motor) of the main blower 10.

The effects of the present invention will be described in comparison of this embodiment with a conventional front air conditioning unit having no sub-blower 27. In the conventional front air conditioning unit having no sub-blower 27, the air passage areas of the rear air ducts 36, 37 are small and substantially long as compared with the front air passage. For this reason, air flow resistance in the rear air ducts 36, 37 becomes substantially large as compared with the air flow resistance in the front air passage. As a result, the volume of air blown off to the rear area is substantially small as compared with the volume of air blown off to the front area to cause an insufficient air conditioning state in the rear area.

According to the first embodiment of the present invention, there is provided with a rear-only sub-blower 27 for increasing the pressure of air blown off to the rear area. Therefore, it is possible to increase the volume of air blown off to the rear area to an appropriate ratio with respect to the volume of air blown off to the front area by selecting the air blowing capacity of the sub-blower 27. Thus, the shortage of air conditioning capacity in the rear area can be effectively prevented.

The sub-blower 27 is integrally arranged with the case 14 of the heat exchange unit 2, thereby being integrated with the case 14. For this reason, the whole case 14 including the sub-blower 27 can be made compact in size. In particular, in the arrangement shown in FIG. 1, the whole unit can be made more compact in size by effectively the arrangement of the heater core 16 slanted to the rear side.

Because the air mixing door 19 constructed of the rotatable plate door is provided as the front temperature adjusting unit, the heater core 16 is arranged to be slanted to the rear side of the vehicle so as to ensure the space in which the air mixing door 19 can turn. With this slanting arrangement of the heater core 16, a dead space is produced in the lower portion on the rear side of the vehicle of the heater core 16, and the sub-blower 27 is arranged in this dead space. Thus, it is possible to further reduce the size of the whole unit including the rear sub-blower 27.

By selecting a blower of large air volume and low pressure loss type as the main blower 10 and by selecting a rear-only blower of small air volume and high pressure type as the sub-blower 27, it is possible to provide air blowing characteristics respectively suitable for the air blowing characteristics of the front air conditioning unit and for the air blowing characteristics for the rear area.

In addition, by controlling the input voltage of the driving motor 27c of the sub-blower 27 independently from the input voltage of the driving motor 12 of the main blower 10, it is possible to control the volume of air blown off to the rear seat area independently from the volume of air blown off to the front seat area of the passenger compartment. That is, it is possible to control the front-blowing air volume independently from the rear-blowing air volume.

The rear sub-blower 27 sucks cold air and hot air and can sufficiently mix the cold air and the hot air in the sub-blower 27. Thus, even if the mixed air is branched into the rear face duct 36 and the rear foot duct 37 directly behind the sub-blower 27, it is possible to send conditioned air having small variations in temperature into both of the ducts 36, 37.

The sub-blower 27 is arranged in the lower portion on the rear side of the vehicle in the case 14 of the heat exchange unit 2 of the front air conditioning unit. Thus, there is an advantage that the operation noises of the rear sub-blower 27 are hard to propagate to the passenger on the front seat. That is, a front air outlet port nearest to the head of the passenger on the front seat is the center face air outlet port (not shown) located at the center of the vehicle instrument panel. Then, by arranging the sub-blower 27 in the lower position of the case 14, as described above, it is possible to locate the sub-blower 27 away from the center face air outlet port and hence to cause for the operation noises of the sub-blower 27 to become hard to propagate to the passenger on the front seat.

A first air passage of the present invention for the front seat side is constructed of the front cold air passage 17, the front air mixing portion 20 and the front air outlet openings 21, 22, 23 in the first embodiment, and the second air passage of the present invention for the rear seat side is constructed of the rear cold air passage 18, the hot air inlet spaces 27k, the cold air inlet spaces 27m, and the rear air duct 28. Further, the hot air inlet spaces 27k construct the hot air passages in the second air passage of the present invention and the cold air inlet spaces 27m construct the cold air passages in the second air passage of the present invention.

(Second Embodiment)

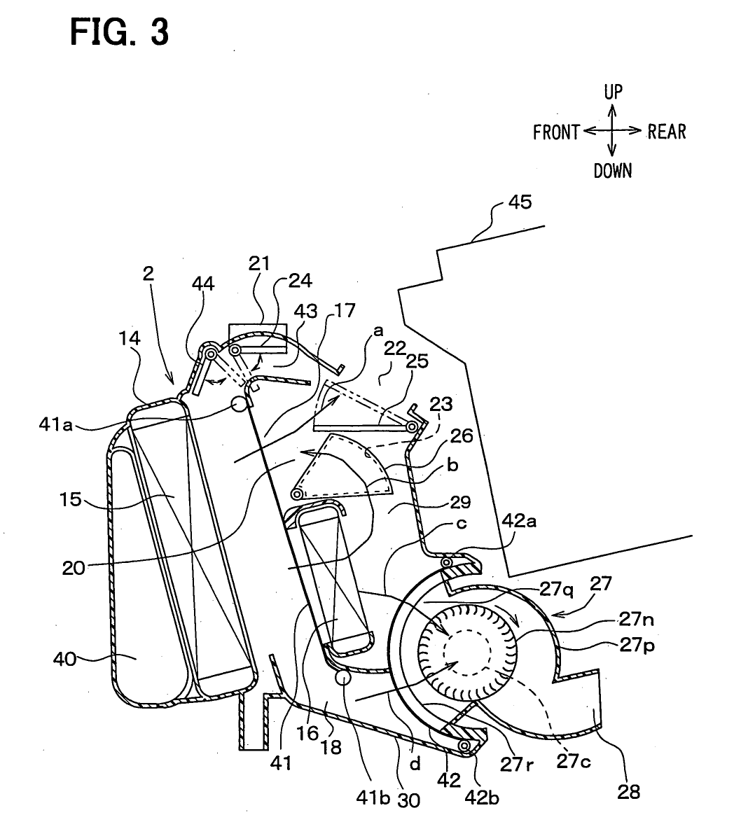

The second embodiment of the present invention will be now described with reference to FIG. 3.

In the above-described first embodiment, the centrifugal fans 27a, 27b in which air flows in the radial direction of a fan impeller are used as the sub-blower 27. However, in the second embodiment, as shown in FIG. 3, a cross flow fan 27n in which air flows through a section normal to the axis of the fan impeller is used as the sub-blower 27.

In FIG. 3, the same parts as in the first embodiment are denoted by the same reference symbols and their descriptions will be omitted. An air inlet space 40 through which air sent from the blower unit 1 flows is formed in the front portion in the case 14. In the second embodiment, the front temperature adjusting unit and the rear temperature adjusting unit are constructed of well-known film doors 41, 42.

The front film door 41 is made of a flexible resin film material (resin thin film-shaped member). Both ends of the front film door 41 are connected to a first winding shaft 41a and a second winding shaft 41b. The front film door 41 is moved up and down in FIG. 3 by winding or rewinding the front film door 41 around the first and second winding shafts 41a, 41b. The front film door 41 has an opening (not shown) large enough to fully open the air passage of the heater core 16 and the front cold air passage 17. By moving this opening and the film portion of the front film door 41 across the air passage of the heater core 16 and the front cold air passage 17, it is possible to adjust the opening of the air passage of the heater core 16 (that is, the volume of cold air “a”) and the opening of the front cold air passage 17 (that is, the volume of hot air “b”), and thereby adjusting the temperature of air blown off to the front area of the passenger compartment.

In the rear sub-blower 27, the cross flow fan 27n is shaped like a cylinder extending in a direction perpendicular to the surface of paper in FIG. 3 (in the lateral direction of the vehicle), and a case 27p for receiving the cross flow fan 27n is also formed in a shape extending in a direction perpendicular to the surface of paper in FIG. 3 (in the lateral direction of the vehicle).

A rear hot air suction port 27q into which hot air after passing through the heater core 16 flows, as shown by arrow “c” in FIG. 3, is arranged in an upper portion on the front side of the vehicle of the case 27p, and a rear cold air suction port 27r into which cold air from the rear cold air passage 18 flows, as shown by arrow “d”, is arranged in a lower portion on the front side of the vehicle of the case 27p. The rear hot air suction port 27q and the rear cold air suction port 27r are arranged in the shape of an arc along the outer peripheral surface of the cross flow fan 27n.

Both ends of the rear film door 42 are connected to a first winding shaft 42a and a second winding shaft 42b. The rear film door 42 is moved up and down in FIG. 3 along the surface of the openings of the rear hot air suction port 27q and rear cold air suction port 27r by winding or rewinding the rear film door 42 around the first and second winding shafts 42a, 42b.

The rear film door 42 has an opening (not shown) large enough to fully open the rear hot air suction port 27q and the rear cold air suction port 27r. By moving this opening and the film portion of the rear film door 42 across the rear hot air suction port 27q and the rear cold air suction port 27r, it is possible to adjust the opening of the rear hot air suction port 27q (that is, the volume of hot air “c”) and the opening of the rear cold air suction port 27r (that is, the volume of cold air “d”) so as to adjust the temperature of air blown off to the rear area of the passenger compartment.

A rear air duct 28 for blowing air sent from the cross flow fan 27n is formed at a portion on the rear side of the vehicle of the case 27p of the sub-blower 27. Also in the second embodiment, the case 27p of the sub-blower 27 and the rear air duct 28 are formed integrally with the left and right division case bodies 14b, 14c (see FIG. 2) of the case 14.

Then, also in the second embodiment, the tip portion on the rear side of the vehicle of the rear air duct 28 is branched into the rear face opening 33 (see FIG. 1) and the rear foot opening 34 (see FIG. 1) located in the lower portion. Then, the rear face opening 33 and the rear foot opening 34 are opened or closed by the rear air outlet mode door 35 (see FIG. 1).

In the second embodiment of the present invention, a cold air bypass passage 43 for directly introducing cold air directly behind the evaporator 15 toward the side of the front face opening 22 is formed in the uppermost portion in the case 14 and the cold air bypass passage 43 is opened or closed by a cold air bypass door 44.

According to the second embodiment, the front temperature adjusting unit and the rear temperature adjusting unit are constructed of the film doors 41, 42 moving in a vertical direction, respectively, so the heat exchange unit 2 can be reduced in size in the longitudinal direction of the vehicle. For this reason, when units 45 such as an audio unit and a navigation unit are mounted in the vehicle instrument portion, it is possible to easily ensure the space where these units 45 are mounted. Then, the sub-blower 27 is arranged in a space below the units 45 such as the audio unit and the navigation unit, so it is possible to easily mount the sub-blower 27 without interfering with these units 45. Moreover, the cross flow fan 27n in which air flows in the direction normal to the axis of the fan impeller is used as the blower fan of the sub-blower 27, so it is possible to form both of the air suction ports 27q and 27r and the air duct 28 across the whole portion in the lateral direction of the heat exchange unit 2 and to suck or blow air from or off to the whole portion in the left and right (lateral) direction of the heat exchange unit 2. Thus, it is possible to reduce pressure loss in the air passage formed on the rear seat side in the case 14.

(Third Embodiment)

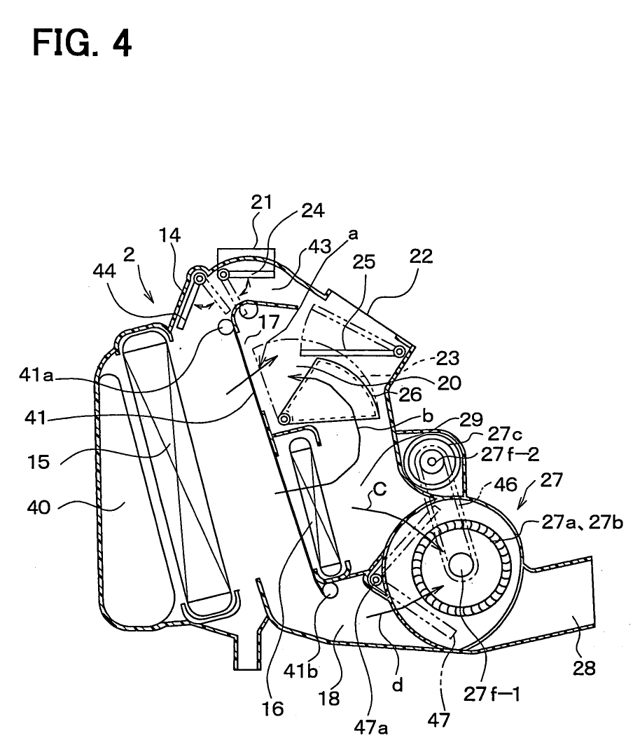

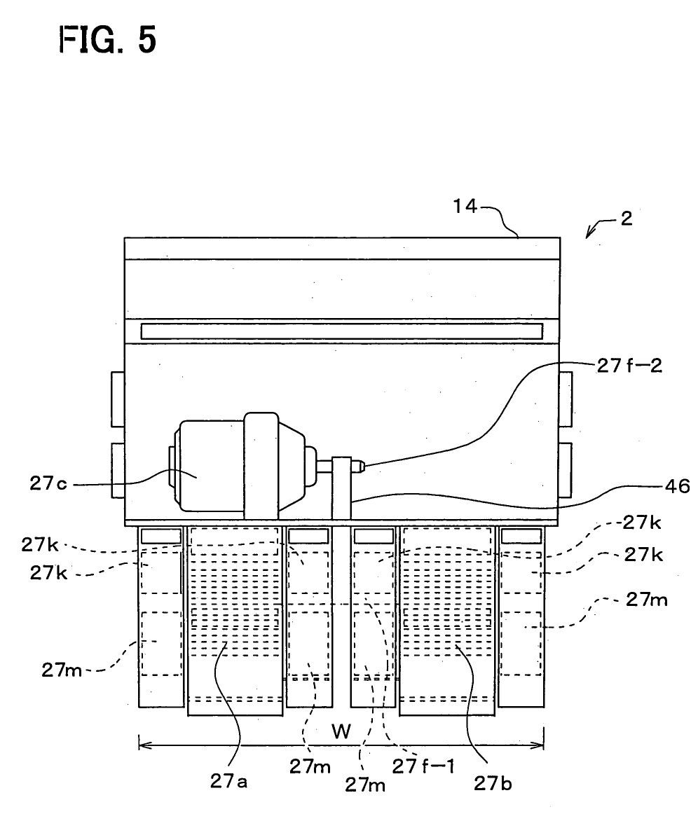

The third embodiment of the present invention will be now described with reference to FIGS. 4 and 5.

In the first embodiment, when the rear sub-blower 27 is constructed of blower fans 27a, 27b each made of a centrifugal fan, the driving motor 27 is formed in double shaft type and the blower fans 27a, 27b are arranged on the left and right sides in the axial direction of the driving motor 27c. In the third embodiment, however, when the sub-blower 27 is constructed by the use of the blower fans 27a, 27b each made of a centrifugal fan, as shown in FIGS. 4, 5, the driving motor 27c is provided with another rotary shaft 27f-2 parallel to the rotary shaft 27f-1 of the blower fans 27a, 27b and is arranged on the outer peripheral side of the blower fans 27a, 27b.

Then, the motor rotary shaft 27f-2 is connected to the fan rotary shaft 27f-1 by using a belt 46 to transmit the rotation of the driving motor 27c to the blower fans 27a, 27b via the belt 46.

According to the third embodiment of the present invention, it is not necessary to arrange the driving motor 27c and the blower fans 27a, 27b in a line in the axial direction just as with the first embodiment. Thus, as shown in FIG. 4, the driving motor 27c can be arranged in an upper portion on the outer peripheral side of the blower fans 27a, 27b. With this arrangement, the size W in the lateral direction of the vehicle of the whole sub-blower 27 (see FIG. 5) can be reduced by a size in the axial direction of the driving motor 27c as compared with the first embodiment. This can effectively expand a space at the feet area of the passenger on the front seat in the passenger compartment.

In the third embodiment of the present invention, rear air mixing doors 47 each of which is constructed of a plate door rotatable around a rotary shaft 47a are used as the rear temperature adjusting unit. The air mixing doors 47 are arranged on both of the left and right sides of two blower fans 27a, 27b, so the air mixing doors 47 total up to four. The four air mixing doors 47 are connected to and operated in association with each other by a rear temperature adjusting mechanism (not shown) via a link mechanism (not shown). The rear temperature adjusting mechanism is constructed of an actuator mechanism using a servomotor.

In FIG. 5, rectangular portions shown by broken lines (i.e., the portion indicated by 27k) in the upper portions on the left and right sides of two blower fans 27a, 27b are inlet openings of the hot air inlet spaces 27k, so the blower fans 27a, 27b suck hot air after passing the heater core, as shown by arrow “c” (FIG. 4). Then, rectangular portions shown by broken lines (i.e., the portion indicated by 27m) in the lower portions on the left and right sides of two blower fans 27a, 27b are inlet openings of the cold air inlet spaces 27m, so the blower fans 27a, 27b suck cold air from the rear cold air passage 18, as shown by arrow “d” (FIG. 4). Four air mixing doors 47 open or close the inlet openings of the hot air inlet spaces 27k and the inlet openings of the cold air inlet spaces 27m to adjust the ratio of hot air volume and the cold air volume for the rear seat side in the passenger compartment.

Here, the rear air mixing doors 47 according to the third embodiment can not totally close the inlet openings of the hot air inlet spaces 27k and the inlet openings of the cold air inlet spaces 27m at the same time, so the rear shut state can be set by the use of the air mixing doors 47. Thus, in the third embodiment, the rear shut state can be set by constructing the rear air outlet mode door 35 (FIG. 1) with a butterfly door, for example.

(Fourth Embodiment)

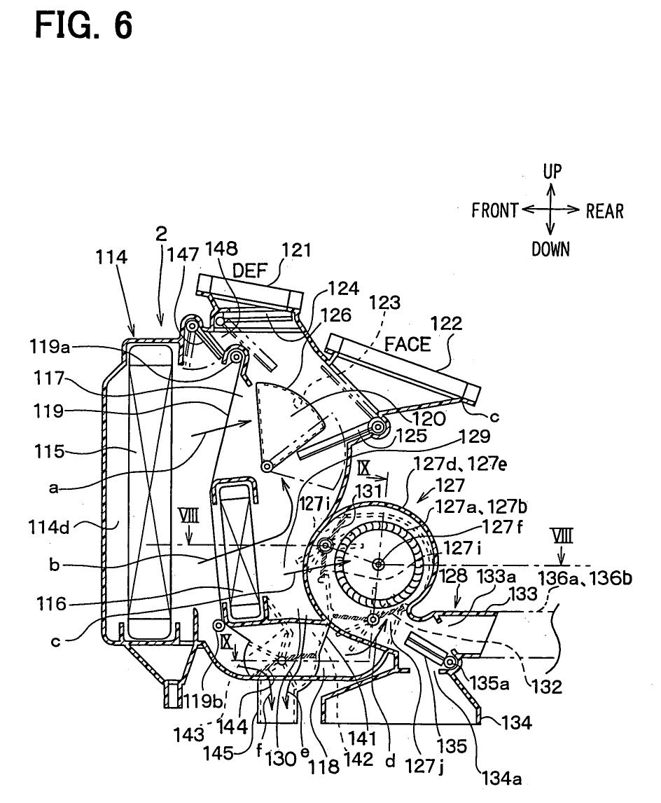

The fourth embodiment of the present invention will be now described with reference to FIGS. 6-10.

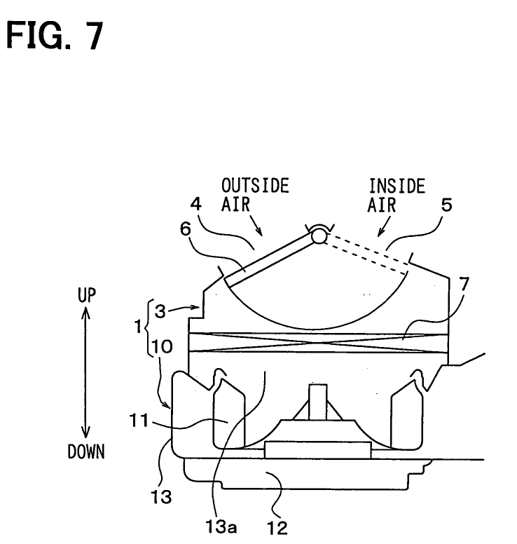

In the fourth embodiment of the present invention, the interior air conditioning device is broadly divided into the blower unit 1 shown in FIG. 7 and the heat exchange unit 2 shown in FIG. 6. The heat exchange unit 2 is arranged nearly in the center in the lateral direction of the vehicle inside the instrument panel (i.e., dashboard) on the front side in the passenger compartment. The blower unit 1 is arranged at a position offset from the heat exchange unit 2 to the front passenger's seat side in the lateral direction of the vehicle. The blower unit 1 in the fourth embodiment has the same structure as that in the first embodiment and hence its description will be omitted.

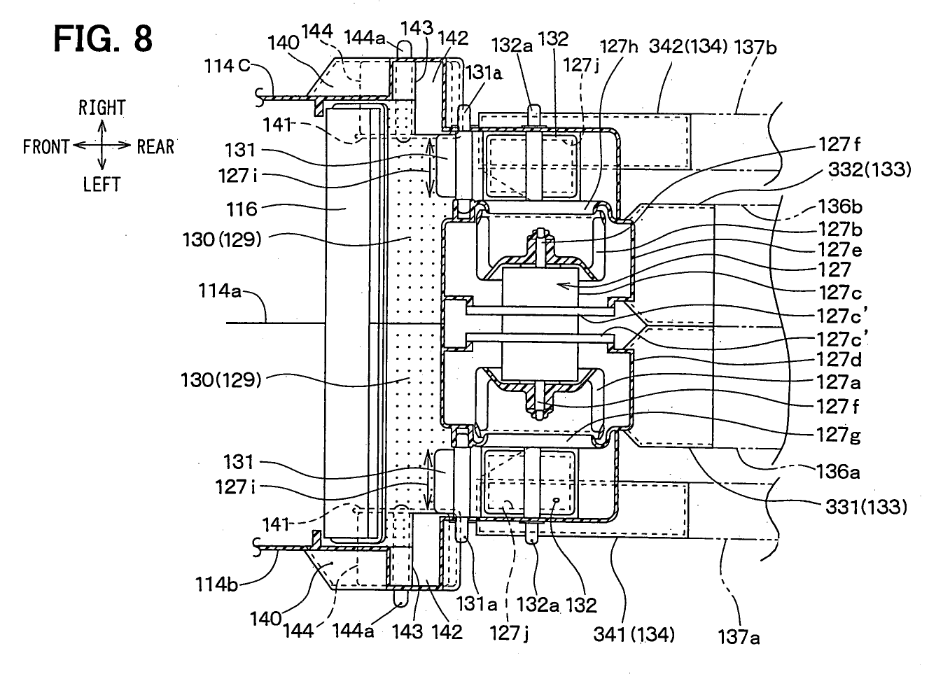

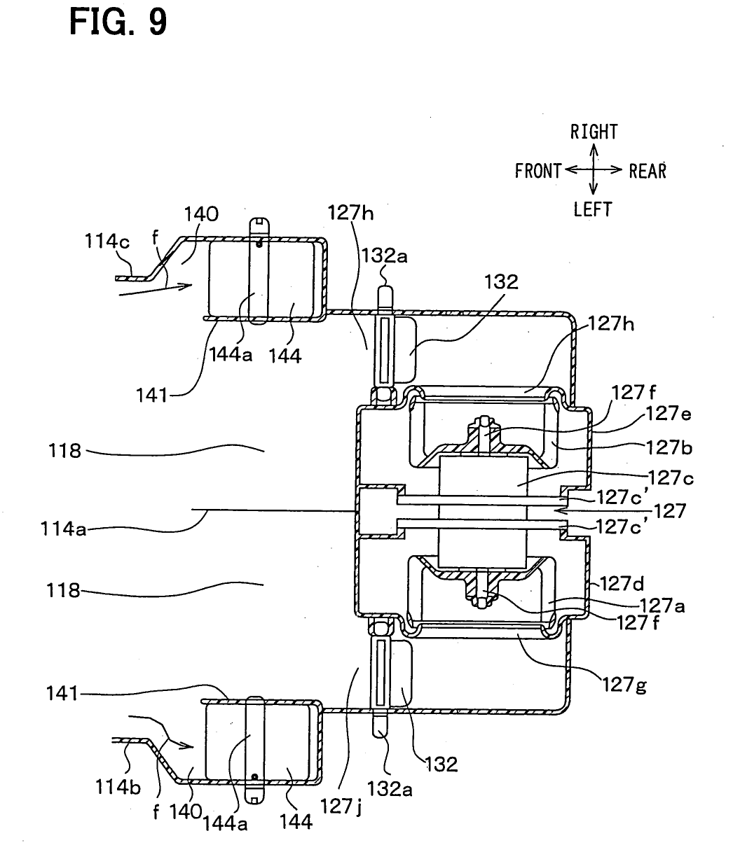

The heat exchange unit 2 has a case 114 made of resin. The case 114, as shown in FIGS. 8, 9, is constructed by connecting two division cases 114b, 114c, which are divided into two left and right parts at a division plane 114a located at the center in the lateral direction of the vehicle. The division cases 114b, 114c are joined into one piece by a fastening member (not shown) such as a suitable clamp and the like. An inlet space 114d to which air outlet of the scroll case 113 is connected is formed at the front portion in the case 114, as shown in FIG. 6. Thus, air flows into the inlet space 114d at the front portion in the case 114 by operation of the blower fan 11 in the blower unit 1.

Air sent by the blower unit 1 flows through the case 114 from the front side of the vehicle to the rear side of the vehicle. Further, an evaporator 115 and a heater core 116 are arranged in series in order from the upstream side of air flow in the case 114. The evaporator 15 is a cooling heat exchanger for cooling air in the case 114.

The heater core 116 is a heating heat exchanger for heating air in the case 114 by using hot water (engine cooling water) flowing therethrough as a heat source.

In the case 114, a front cold air passage 117 is formed above the heater core 116 and a rear cold air passage 118 is formed below the heater core 116. Cold air passing through the evaporator 115 bypasses the heater core 116 while flowing through these cold air passages 117, 118.

A front air mixing door 119 is disposed between the evaporator 115 and the heater core 116 in the case 114. The front air mixing door 119, in this embodiment, is constructed of a film door. Here, the film door is formed of a flexible thin resin film material.

Both ends in the direction of motion (in the vertical direction) of the front air mixing door 119 are connected to a first winding shaft 119a and a second winding shaft 119b. By winding or unwinding the front air mixing door 119 around or from the first and second winding shafts 119a, 119b, the front air mixing door 119 is moved in the vertical direction. An opening (not shown) for passing air is open at a middle portion in the direction of movement of the front air mixing door 119. The opening of the front air mixing door 119 is set at a size necessary to fully open the air passage of the heater core 116 and the front cold air passage 117.

By moving the opening and film portion of the front air mixing door 119 across the air passage of the heater core 116 and the front cold air passage 117, the opening degree of the air passage of the heater core 116 (that is, the volume of hot air “b”) and the opening degree of the front cold air passage 117 (that is, the volume of hot air “a”) can be adjusted and hence the air temperature to be blown toward the front area of the passenger compartment can be adjusted. Thus, the front temperature adjusting unit is constructed of the front air mixing door 119.

Any one of the first and second winding shafts 119a, 119b of the front air mixing door 119 becomes a driving shaft and the other shaft becomes a driven shaft. Then, among the first and second winding shafts 119a, 119b, the winding shaft which becomes the driving shaft is connected to and rotated by the front temperature adjusting mechanism (not shown). The front temperature adjusting mechanism is constructed of an actuator mechanism using a servomotor.

A front air mixing portion 120 where cold air “a” from the front cold air passage 117 is mixed with hot air “b” from the heater core 116 is formed on the upper rear side of the heater core 116 in the case 114. A plurality of front air outlet openings 121, 122, 123 are arranged in the upper portion on the rear side of the vehicle in the case 114. Conditioned air from the front air mixing portion 120 flows into the front air outlet openings 121, 122, 123.

A defroster opening 121 of the front air outlet openings 121, 122, 123 is open at the upper surface of the case 114 and communicates with a defroster air outlet port (not shown) so as to blow off conditioned air toward the windshield glass in the passenger compartment through a defroster duct (not shown). The defroster opening 121 is opened or closed by a defroster door 124.

A front face opening 122 is open at a rear portion of the vehicle of the defroster opening 121 in the upper surface of the case 114. The front face opening 122 communicates with a front face air outlet port (not shown) for blowing off conditioned air toward the upper half body of the passenger on the front seat through a front face duct (not shown). Then, the front face opening 122 is opened or closed by a front face door 125.

Front foot openings 123 are open at portions located on both left and right sides of the front air mixing portion 120 of the left and right side walls (designated by reference symbols 114b, 114c in FIG. 8, FIG. 9) of the case 114. The front foot openings 123 communicate with front foot air outlet ports (not shown) for blowing off conditioned air toward the feet of the passenger on the front seat through a front foot duct (not shown). The front foot openings 123 on both left and right sides are opened or closed by front foot doors 126 on both left and right sides.

Here, each of the front foot openings 123 and the front foot doors 126, in this embodiment, is shaped like a fan. Then, the left and right fan-shaped front foot doors 126 are turned along the left and right side walls of the case 114, so that the front foot openings 123 are opened and closed. The position of the front door 126, shown by solid line in FIG. 6, shows the state where the front foot opening 123 is fully closed.

The above-described doors 124, 125, 126 construct front air outlet mode doors for switching front air-outlet modes and are connected to and operated in association with each other by a common front air-outlet mode operating mechanism vie a link mechanism (not shown). The front air outlet mode operating mechanism is constructed of an actuator mechanism using a servomotor.

In this regard, in this embodiment, a front cold air bypass passage 148 for directly introducing cold air directly behind the evaporator 115 into the front face opening 122 is formed in the uppermost portion in the case 114, and the front cold air bypass passage 148 is opened or closed by a front cold air bypass door 147.

A sub-blower 127 is arranged at a position separated by a predetermined distance away from the bottom of the heater core 116 to the downstream side of air flow in the lower portion in the case 114. The sub-blower 127, as shown in FIG. 8 and FIG. 9, has two blower fans 127a, 127b, a driving motor 127c for rotating the two blower fans 127a, 127b, and spiral scroll cases 127d, 127e for receiving the blower fans 127a, 127b.

Here, as shown in FIG. 6, each of the blower fans 127a, 127b is constructed of a centrifugal fan in which a large number of blades are annularly arranged.

The left and right scroll cases 127d, 127e are integrally molded of resin together with the left and right division case bodies 114b, 114c, respectively. Then, a rear air duct 128 (FIG. 6) is arranged on the down stream side (rear side of the vehicle) of each of the left and right scroll cases 127d, 127e. The rear air duct 128 joins airs blown from the outlets of the scroll cases 127d, 127e and guides them toward the rear side of the vehicle. The rear air ducts 128 are also integrally formed from a resin with the left and right division case bodies 114b, 114c, respectively.

The driving motor 127c of the sub-blower 127 is a double shaft type motor in which its rotary shaft 127f protrudes to both sides in the axial direction, and is arranged generally in the center in the lateral direction of the vehicle in the case 114 in such a way that the rotary shaft 127f faces in the lateral direction of the vehicle. Here, the driving motor 127c, in this embodiment, is constructed of a brushless motor and is fixed to left and right scroll cases 127d, 127e via two circular flange parts 127c′.

The blower fans 127a, 127b are arranged on both left and right sides of the driving motor 127c, and the left and right blower fans 127a, 127b are connected to the left and right rotary shafts 127f. Air suction ports 127g, 127h shaped like a bell mouth are formed on the left side of the left scroll case 127d and on the right side of the right scroll case 127e, respectively.

Cold air and hot air are sucked into the above-described air suction ports 127g, 127h through a passage construction to be described below. A partition wall 130 is arranged for partitioning a hot air passage 129 (FIG. 6) formed directly behind the heater core 116 and the above-described rear cold air passage 118 into upper and lower portions. The partition wall 130, as shown in FIG. 6, is arranged in such a way as to protrude from the bottom of the heater core 116 to the downstream side of the air flow (rear side of the vehicle).

In FIG. 8, an area where the partition wall 130 is arranged is shown by small dots. As shown by the dotted area in FIG. 8, the partition wall 130 is arranged across the whole area in the case 114 in the lateral direction of the vehicle. Here, the partition wall 130 is integrally molded of resin with the left and right division case bodies 114b, 114c, respectively.

Then, air inlet spaces are formed on the left side of the left air suction port 127g and on the right side of the right air suction port 127h. A rear hot air inlet 127i into which hot air from the hot air passage 129 flows, as shown arrow “c”, is formed in an area shown by arrows in FIG. 8 in a portion above the partition wall 130 of the air inlet space. Then, a rear cold air inlet 127j into which cold air from the cold air passage 118 flows, as shown arrow “d”, is formed in a nearly rear portion of the partition wall 130 of the above-described air inlet space.

A hot air door 131 is arranged in each of two left and right rear hot air inlets 127i, and a cold air door 132 is arranged in each of two left and right rear cold air inlets 127j. Each of the hot air doors 131 and cold air doors 132, in this embodiment, is constructed of a butterfly type plate door shaped like a letter V and capable of turning around the rotary shafts 131a, 132a, respectively. By adjusting the rotation angles of the hot air doors 131 and the cold air doors 132, the air passage areas of the rear hot air inlets 127i and the rear cold air inlets 127j can be adjusted.

Two hot air doors 131 and two cold air doors 132 construct a rear temperature adjusting unit for adjusting the temperature of air blown off to the rear side in the passenger compartment. In this embodiment, two hot air doors 131 are connected to and operated in association with each other by a rear hot-air side operating unit (not shown) via a link mechanism (not shown). Then, two cold air doors 132 are also connected to and operated in association with each other by the rear cold-air side operating unit (not shown) via a link mechanism (not shown). Each of the rear hot air side operating unit and the rear cold-air side operating unit is constructed of an actuator mechanism using an independent servomotor.

Because each of the rear hot air side operating unit and the rear cold air side operating unit is constructed of the actuator mechanism using an independent servomotor in this manner, the rear shut state can be readily set. In the rear shut state, the rear hot air inlets 127i are fully closed by two hot air doors 131 and the cold air inlets 127j are fully closed at the same time by two cold air doors 132.

On the other hand, in a state where air blows off to the rear seat side in the passenger compartment, in order to adjust the temperature of air blown off to the rear seat side in the passenger compartment, the rear hot air side operating unit and the rear cold air side operating unit are operatively electrically linked with each other. More specifically, in the maximum heating, the rear hot air inlets 127i are fully opened by the two hot air doors 131 and the rear cold air inlets 127j are fully closed by the two cold air doors 132. Conversely, in the maximum cooling, the rear hot air inlets 127i are fully closed by the two hot air doors 131 and the rear cold air inlets 127j are fully opened by the two cold air doors 132.

Then, in a middle temperature control between the maximum heating and the maximum cooling, the hot air doors 131 and the cold air doors 132 continuously vary rotation positions between a maximum heating position and a maximum cooling position to adjust the air passage areas of the rear hot air inlets 127i and the rear cold air inlets 127j. That is, in the middle temperature control, when the hot air doors 131 turn to the side to totally close the rear hot air inlets 127i, the cold air doors 132 turn to the side to fully open the rear cold air inlets 127j. Therefore, both the doors 131, 132 adjust the air passage areas of the rear hot air inlets 127i and the rear cold air inlets 127j in a canceling manner.

The downstream side of the rear air duct 128, as shown in FIG. 6, is branched into a rear face duct 133 located on an upper side and a rear foot duct 134 located on a lower side. Then, a rear air-outlet mode door 135 is arranged inside the rear air duct 128.

The rear air outlet mode door 135, in this embodiment, is constructed of a plate door capable of turning around a rotary shaft 135a, and opens and closes a rear face opening 133a in the rear face duct 133 and a rear foot opening 134a in the rear foot duct 134. The rear air outlet mode door 135 is connected to and operated by a rear air-outlet mode operating mechanism. The rear air-outlet mode operating mechanism is constructed of an actuator mechanism using a servomotor.

Here, the rear face duct 133, as shown in FIG. 8, is branched into a rear left face duct 331 and a rear right face duct 332. A rear left face duct 136a and a rear right face duct 136b, which are formed separately from the left and right face ducts 331, 332, are connected to these left and right face ducts 331, 332, respectively. Conditioned air blows off to the upper half body of the passenger on the rear seat from rear face outlet ports (not shown) provided at the tip portions (downstream end portions) of these rear left and right face ducts 136a, 136b.

Similarly, the rear foot duct 134 is also branched into a rear left foot duct 341 and a rear right foot duct 342. A rear left foot duct 137a and a rear right foot duct 137b, which are formed separately from the left and right foot ducts 341, 342, are connected to the left and right foot ducts 341, 342, respectively. Conditioned air blows off to the feet of the passenger on the rear seat from rear foot air outlet ports (not shown) provided at the tip portions (i.e., downstream end portions) of these rear left and right foot ducts 136a, 136b.

Each of the rear face ducts 136a, 136b and the rear foot ducts 137a, 137b is shaped like a slender duct extending to the rear area in the passenger compartment. The existence of these slender ducts 136a, 136b, 137a, 137b substantially increases air flow resistance in the rear air passage as compared with air flow resistance in the front air passage.

In this embodiment, there is provided with an air passage through which conditioned air flows to the front seat (not shown) on which the passenger sits. Next, the construction of the air passage for seat will be described. Cold air introduction passages 140 for seat, into which a part of cold air from a rear cold air passage 118 as shown by arrow “f” (FIG. 6 and FIG. 9), are formed in lower portions on the left and right outsides of the heater core 116 in the left and right division cases 114b, 114c.

Each of the cold air introduction passages 140 for seat is separated from the rear cold air passage 118 by a partition plate 141 in the lateral direction of the vehicle. They are formed on both left and right sides of the rear cold air passage 118. The partition plate 141 is shaped like a plate extending in the vertical direction in a space between the bottom portions of each of the division cases 114b, 114c and the partition wall 130. Thus, the partition plate 141 is arranged vertically to a surface extending in the lateral direction of the vehicle of the heater corer 116.

A hot air introduction passage 142 for seat is arranged on the downstream side (on the rear side of the vehicle) of each of the left and right cold air introduction passages 140 for seat. The hot air introduction passage 142 introduces a part of hot air in the hot air passage 129 on the downstream side of the heater core 116, that is, introduces a part of hot air above the partition wall 130, as shown by arrow “e” (FIG. 6), below the partition wall 130. A partition plate 143 is arranged on the front side of the vehicle of each of the left and right hot air introduction passages 142 for seat (FIG. 6, FIG. 8). The partition plate 143 partitions the front side of the vehicle of the hot air introduction passage 142 for seat to prevent the hot air introduction passage 142 for seat from directly communicating with the cold air introduction passage 140 for seat.

An air mixing door 144 for seat is arranged at a part of each of left and right sides where the cold air introduction passage 140 for seat joins with the hot air introduction passage 142 for seat. The air mixing door 144 for seat adjusts the air passage area of the cold air introduction passage 140 for seat, that is, the cold air volume to be blown to the seat and the air passage area of the hot air introduction passage 142 for seat, that is, the hot air volume to be blown to the seat. Thus, a seat temperature adjusting unit for adjusting the temperature of air blown off to the seat is constructed of the air mixing door 144 for seat.

Here, the air mixing door 144 for seat on each of the left and right sides, in this embodiment, is constructed of a butterfly type plate door shaped like a letter V and capable of turning around a rotary shaft 144a.

An air duct 145 for seat is arranged below the cold air introduction passage 140 for seat and the hot air introduction passage 142 for seat on each of the left and right sides. The air duct 145 for seat takes out conditioned air whose temperature is controlled by the opening degree of the air mixing door 144 for seat on each of the left and right sides. The air duct 145 for seat on each of the left and right sides is integrally formed with each of the left and right division case bodies 114b, 114c in such a way as to protrude downward from the bottom portion of each of the left and right division case bodies 114b, 114c.

A left seat duct (not shown) is connected to the left air duct 145 for seat, and the tip of the left seat duct is connected to the air passage of the front left seat (i.e., the front passenger's seat in a right-hand drive vehicle) in the passenger compartment to blow off conditioned air to the surface of the front left seat. Similarly, a right seat duct (not shown) is connected to the right air duct 145 for seat and the tip of the right seat duct is connected to the air passage of the front right seat (i.e., the driver's seat in a right-hand drive vehicle) in the passenger compartment to blow off conditioned air to the surface of the right seat.

The rotary shaft 144a of the air mixing door 144 for seat on each of the left and right sides is connected to and turned by a seat temperature adjusting mechanism via a link mechanism. The seat temperature adjusting mechanism is constructed of an actuator mechanism using a servomotor.

As can be seen from FIG. 8 and FIG. 9, the rear hot air introduction inlets 127i, the rear cold air passages 118, the rear cold air inlets 127j, the rear hot air doors 131, and rear cold air doors 132 are arranged nearer to the center in the lateral direction of the vehicle. Then, the cold air introduction passages 140 for seat and the hot air introduction passages 142 for seat and the air mixing doors 144 for seat are arranged on the left and right outsides of these parts.

Here, the operations of the actuator mechanisms of the above-described various operating units, the main blower 110 and the sub-blower 127 are controlled by a well-known air conditioning controller (not shown) using a microcomputer.

Next, the operation of this embodiment will be described in the above-described construction. When conditioned air blows off only to the front seat side in the passenger compartment, the driving motor 12 of the main blower 10 of the blower unit 1 is energized to rotate the blower fan 11. Then, the supply of current to the driving motor 127c of the sub-blower 127 is stopped to stop the blower fans 127a, 127b of the sub-blower 127.

With this operation, only the main blower 10 is operated, whereby air sent by the main blower 10 is passed through the evaporator 115, thereby being cooled and dehumidified. Then, cold air after passing through the evaporator 115 is branched, by the front air mixing door 119, into cold air “a” passing through the front cold air passage 117 and air that passes through the heater core 116 and becomes hot air “b”. For this reason, by adjusting the ratio between the volume of cold air “a” and the volume of hot air “b” by the movement position of the front air mixing door 119, the temperature of air blown off to the front seat in the passenger compartment can be adjusted.

The cold air “a” is mixed with the hot air “b” in the air mixing portion 120 to become conditioned air having a desired temperature. Then, the conditioned air blows off to the front area in the passenger compartment from at least one of the front air outlet openings 121, 122, 123 selected from the front seat air outlet mode doors 124, 125, 126 to perform air-conditioning of the front area in the passenger compartment.

At this time, the rear shut state is set in association with the stopping operation of the sub-blower 127. When it is determined by the air conditioning controller that the operation of the rear sub-blower 127 is stopped, and the rear hot air side operating mechanism is driven by the control output of the air conditioning controller to operate the two hot air doors 131 at the positions where the rear hot air inlets 127i are fully closed (at the diagonally shaded positions in FIG. 6). At the same time, the rear cold air side operating mechanism is driven by the control output of the air conditioning controller to operate the two cold doors 132 to the positions where the rear cold air inlets 127j are fully closed (at the diagonally shaded positions in FIG. 6). With this operation, the rear shut state can be set to prevent conditioned air from blowing off to the rear area in the passenger compartment.

Then, when both of the left and right seat air mixing doors 144 are operated to the diagonally shaded turning positions in FIG. 6 by the temperature adjusting mechanism for seat, both of the left and right cold air introduction passages 140 for seat and the left and right hot air introduction passages 142 for seat can be fully closed by the seat air mixing doors 144. With this operation, a seat side shut state can be set to prevent conditioned air from blowing off from the surface of the seat.

Next, when conditioned air blows off at the same time to both of the front seat side in the passenger compartment and the rear seat side in the passenger compartment, the driving motor 12 of the main blower 10 of the blower unit 1 and the driving motor 127c of the rear sub-blower 127 are energized to operate the main blower 10 and the rear sub-blower 127 at the same time.

With this operation, air sent by the main blower 10 is sent to the front area in the passenger compartment through the same route described above to blow off conditioned air to the front area in the passenger compartment from at least one of front air outlet openings 121, 122, 123 to perform air-conditioning of the front area in the passenger compartment.

On the other hand, when the rear sub-blower 127 is operated, the two hot air doors 131 are operated to the specified opening positions of the rear hot air inlets 127i, and at the same time, the two cold air doors 132 are operated to the specified opening positions of the rear cold air inlets 127j. With this operation, hot air passing through the lower portion of the heat exchange core part of the heater core 116 among hot air passing through and heated by the heater core 116, as shown by arrow “c”, passes through the rear hot air inlets 127i and is sucked into the air suction ports 127g, 127h of the blower fans 127a, 127b. At the same time, cold air passing through the rear cold air passage 118 located below the heater core 116, as shown by arrow “d”, passes through the rear cold air inlets 127j and is sucked into the air suction ports 127g, 127h of the blower fans 127a, 127b.

These hot air and cold air are sent outward in the fan radial direction by the blower fans 127a, 127b and are blown off to the rear air ducts 128 from the outlets of the left and right scroll cases 127d, 127e. The hot air and the cold air are sucked by the blower fans 127a, 127b and mixed while they are sent to the outlets of the scroll cases 127d, 127e, thereby obtaining conditioned air having a desired temperature.

Then, the air passage areas of the rear hot air inlets 127i can be continuously adjusted by the turning positions (i.e., opening degrees) of the rear hot air doors 131. In association with this adjustment of the rear hot air doors 131, the air passage areas of the rear cold air inlets 127j can be continuously adjusted by the turning positions (i.e., opening degrees) of the rear cold air doors 132. Here, the rear hot air doors 131 and the rear cold air doors 132 reversely vary the air passage areas of the rear hot air inlets 127i and the rear cold air inlets 127j. Thus, the ratio between the volume of hot air sucked into the rear hot air inlet 127i and the volume of cold air sucked into the rear cold air inlets 127j can be arbitrarily controlled by adjusting the turning positions (i.e., opening degrees) of the hot air doors 131 and the cold air doors 132 so as to supply the conditioned air having a desired temperature also to the rear seats.

Then, the rear face openings 133 and the rear foot openings 134 are opened or closed by the rear air outlet mode doors 135 arranged in the rear air ducts 128 to open only one of both the openings 133, 134 or both of the openings 133, 134 at the same time. With this operation, the conditioned air having the desired temperature passes through the rear face ducts 136a, 136b or/and the rear foot ducts 137a, 137b, and blows off to the upper half body or the feet area of the passenger on the rear seat from the rear face air outlet ports (not shown) or/and the rear foot air outlet ports (not shown), so that air-conditioning of the rear area in the passenger compartment can be performed.

When the conditioned air blows off to the front seat, by turning the left and right air mixing doors 144 for seat clockwise by a specified angle from the rotation positions in FIG. 6 by use of the temperature adjusting mechanism for seat, it is possible to select a state where one group of the cold air introduction passages 140 for seat on the left and right sides and the hot air introduction passages 142 for seat on left and right sides are opened or a state where both groups of the cold air introduction passages 140 for seat and the hot air introduction passages 142 for seat are opened.

With this operation, the conditioned air can be blown off through the air outlet openings 145 for seat into the front seats. The temperature of the conditioned air blown off into the front seats can be also adjusted to a desired temperature by adjusting the opening degrees (turning positions) of the air mixing doors 144 for seat.

Here, the rear-only sub-blower 127 is a centrifugal blower having characteristics of small air volume and high pressure type, and has a comparatively small fan diameter (for example, fan diameter: approximately 70 mm). The double suction type blower fans 127a, 127b are approximately 70 mm in height in the axial direction.

On the other hand, the main blower 10 is a centrifugal blower having characteristics of large air volume and low pressure loss type. Then, the blower fan 11 is sufficiently large in fan diameter, as compared with the sub-blower 127, and is approximately 160 mm, for example. Then, even in the case of a single suction type blower, the blower fan 11 is sufficiently as large as approximately 80 mm in height in the axial direction.

Next, the effects of this embodiment will be described.

First, similarly to the above-described first embodiment of the present invention, it is possible to increase the volume of air blown off to the rear area without enhancing the capacity of the main blower 110 (i.e., output power of the driving motor).

Moreover, the sub-blower 127 is integrally arranged in the case 114 of the heat exchange unit 2 and the sub-blower 127 is integrated with the heat exchange unit 2, so it is possible to make the whole case 114 including the sub-blower 127 compact in size.

In the fourth embodiment, by controlling the input voltage of the driving motor 127c of the rear sub-blower 127 independently from the input voltage of the driving motor 112 of the main blower 100, it is possible to control the rear-blowing air volume independently from the front-blowing air volume. That is, it is possible to control the front-blowing air volume independently from the rear-blowing air volume.

The sub-blower 127 sucks cold air and hot air and can mix the cold air with the hot air into good condition in the sub-blower 127. Thus, even if the air passage is branched into the rear face ducts 136a, 136b and the rear foot ducts 137a, 137b directly behind the sub-blower 127, it is possible to send conditioned air having small difference in temperature to both groups of the rear face ducts 136a, 136b and the rear foot ducts 137a, 137b.

The rear cold air passages 118, rear cold air inlets 127i and the rear hot air inlets (hot air passages) 127j are arranged in the center area in the left and right direction (lateral direction, width direction) of the vehicle of the heat exchange unit 2, and the cold air introduction passages 140 for seat and the rear hot air introduction passages 142 for seat are arranged on the left and right outsides of the rear cold air passages 118 and the hot and cold air inlets 127j, 127i. For this reason, it is possible to arrange the seat ducts (not shown) on the left and right outsides of the rear face ducts 136a, 136b and the rear foot ducts 137a, 137b. Thus, it is possible to arrange the seat ducts and the rear air ducts 136a, 136b, 137a, 137b toward the front seats and the rear sides without crossing them and hence to simplify the layout of the air conditioning ducts in the passenger compartment.

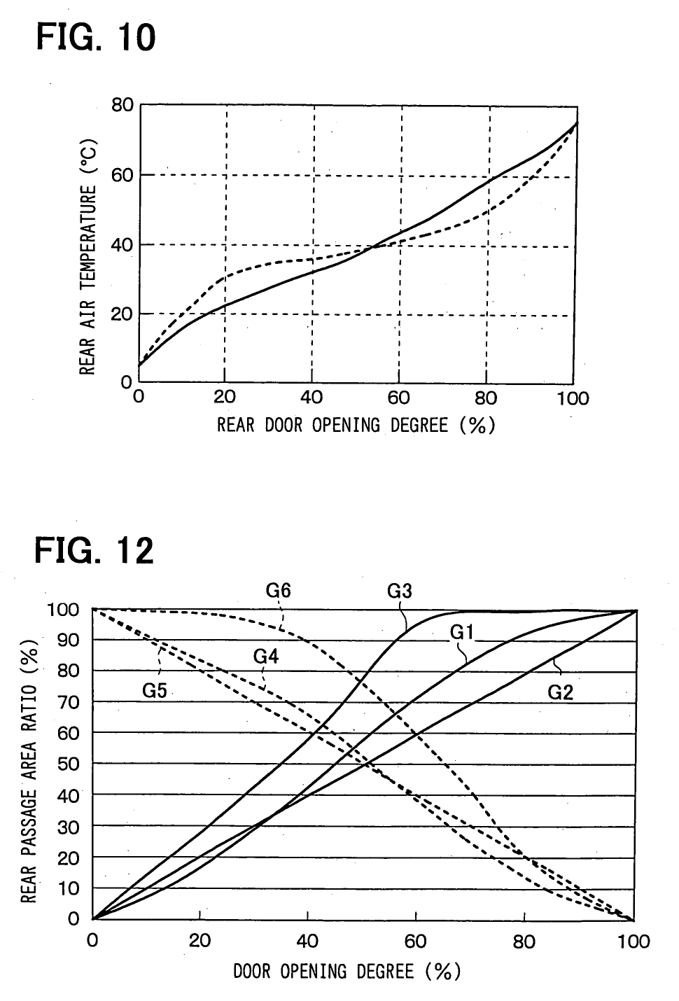

The rear hot air doors 131 for adjusting the air passage areas of the rear hot air inlets 127i and the cold air doors 132 for adjusting the air passage areas of the rear cold air inlets 127j are provided as the rear temperature adjusting unit, and both of the doors 131, 132 are operated in association with each other so that the air passage areas of the rear hot air inlets 127i and the air passage areas of the rear cold air inlets 127j vary in a canceling manner. Thus, as compared with a case where a usual air mixing door made of a single plate door is used as the rear temperature adjusting unit, it is possible to make the control characteristics of a rear-blowing air temperature have excellent linearity, as shown by solid line in FIG. 10.

A vertical axis in FIG. 10 designates a rear-blowing air temperature and a horizontal axis designates the ratio of the movement amount of door (door opening degree) of the rear temperature adjusting unit in a case where the maximum cooling position and the maximum heating position of the rear temperature adjusting unit are set at 0% and 100%, respectively. The broken line in FIG. 10 shows the control characteristics of a rear-blowing air temperature in a case where a usual air mixing door made of a single plate door is used as the rear temperature adjusting unit. As can be seen from FIG. 10, the rear-blowing air temperature varies sharply near the door movement in a range from 0% to 20% and from 80% to 100%, whereas the rear-blowing air temperature varies mildly in the door movement range from 20% to 80%. As a result, the linearity of control characteristics of the rear-blowing air temperature is deteriorated. In contrast to this, the solid line in FIG. 10 shows the control characteristics of the rear-blowing air temperature in accordance with this embodiment in which the rear hot air doors 131 and the rear cold air doors 132 are used in combination. It is possible to remarkably improve the linearity of the temperature control characteristics as compared with a case where the usual air mixing door made of a single plate door is used. Because the rear hot air doors 131 and the rear cold air doors 132 are used in combination, it is possible for both of the air passage areas of the rear hot air inlets 127i and the air passage areas of the rear cold air inlets 127j to vary approximately in proportion to a variation in the movement amount of the door (door opening degree). Therefore, this embodiment can improve the linearity of the temperature control characteristics in this manner.

The rear hot air doors 131 for adjusting the air passage areas of the rear hot air inlets 127i and the rear cold air doors 132 for adjusting the air passage areas of the rear cold air inlets 127j are provided as the rear air temperature adjusting unit. Then, by operating the rear hot air doors 131 to the positions where the rear hot air inlets 127i are fully closed and at the same time by operating the rear cold air doors 132 to the positions where the rear cold air inlets 127j are fully closed, it is possible to set the rear shut state. By the rear air outlet mode doors 135, it is possible to set the rear shut state. In this case, however, air flows into the rear sub-blower 127 to form a vortex to cause noises or increased variations in the temperature of air blown off to the front seat and the like. However, according to this embodiment, in the rear shut state, the upstream air passage of the rear sub-blower 127 can be shut by both of the doors 131, 132, so it is possible to prevent air from flowing into the rear sub-blower 127 and hence to avoid the occurrence of the above troubles.

In order for the blower fans 127a, 127b of the rear sub-blower 127 to smoothly suck air, air suction spaces (spaces on the left and right outsides of the air suction ports 127g, 127h) need to be provided adjacently to the sides in the axial direction of the air suction ports 127g, 127h of the blower fans 127a, 127b. In this embodiment, attention is paid to the existence of these air suction spaces and these air suction spaces are utilized to ensure the turning spaces of the rear hot air doors 131 and the rear cold air doors 132, so it is possible to compactly arrange both of the doors 131, 132 in a space required by the sub-blower 127.

The front air passage of the present invention is constructed of the front cold air passage 117, the front air mixing portion 120, and the front air outlet openings 121, 122, 123 in the fourth embodiment, and the rear air passage of the present invention is constructed of the rear cold air passages 118, the rear hot air inlets 127i, the rear cold air inlets 127j, rear air ducts 128, 133, 134, the rear face ducts 136a, 136b, and the rear foot ducts 137a, 137b.

Further, the rear hot air inlets 127i construct the hot air passage in the rear air passage of the present invention, and the rear cold air inlets 127j construct the cold air passage in the rear air passage of the present invention.

(Fifth Embodiment)

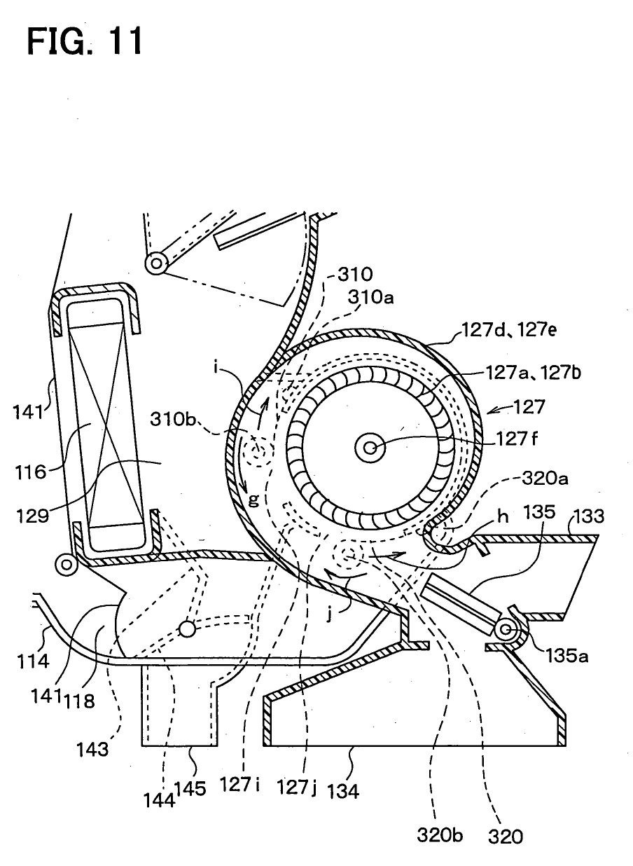

The fifth embodiment of the present invention will be now described with reference to FIGS. 11 and 12.

In the above-described fourth embodiment, the example has been described in which the rear hot air doors 131 and the rear cold air doors 132, each made of a plate door shaped like a butterfly, are used in combination as the rear temperature adjusting unit. In the fifth embodiment, however, as shown in FIG. 11, a rear hot air door 310 and a rear cold air door 320 are used in combination as the rear temperature adjusting unit and these doors 310, 320 are constructed of film doors (film-shaped members), respectively. These hot air film door 310 and cold air film door 320 are constructed of a flexible resin film member having only film-shaped part and no opening.

One ends 310a, 320a of both of the film doors 310, 320 in accordance with the fifth embodiment are fixed to the surface of a case wall for separating the rear hot air inlet 127i from the rear cold air inlet 127j. In contrast to this, the other ends of both of the film doors 310, 320 are connected to winding shafts 310b, 320b, respectively.

The winding shafts 310b, 320b are operated in association with each other by a door operating mechanism (not shown) to move while rotating in the directions to come away from or to come near to the one ends 310a, 320a. Here, the rear hot air inlet 127i and the rear cold air inlet 127j are formed in the shape of an arc on the outer peripheral sides of air suction ports 127g, 127h, each shaped like a bell mouth, of the blower fans 127a, 127b of the rear sub-blower 127. Therefore, the paths of the winding shafts 310b, 320b are shaped like arcs along the arc shapes of the rear hot air inlet 127i and the rear cold air inlet 127j, respectively.

Next, the operation of the fifth embodiment will be now described. When the one end 310b of the hot air film door 310 moves while rotating in a direction “g” to come away from the one end 310a, the other end side of the hot air film door 310 is unwound from the winding shaft 310b to decrease the air passage area of the rear hot air inlet 127i. In response to this operation, the winding shaft 320b of the cold air film door 320 moves while rotating in a direction “h” to come near to the one end 320a to wind up the other end side of the cold film door 320 around the winding shaft 320b to increase the air passage area of the rear cold air inlet 127j.

That is, the air passage area of the rear cold air inlet 127j is increased in response to a decrease in air passage area of the rear hot air inlet 127i, so it is possible to lower the temperature of air blown off to the rear seat of the present invention.

Conversely, when the winding shaft 310b of the hot air film door 310 moves in a direction “i” to come near to the one end 310a, the winding shaft 310b rotates in a direction opposite to the above direction to wind up the other end side of the hot air film door 310 around the winding shaft 310b to increase the air passage area of the rear hot air inlet 127i. In response to this operation, the winding shaft 320b of the cold air film 320 moves while rotating in a direction j to come away from the one end 320a. At this time, the rotational direction of the winding shaft 320b also becomes opposite to the above direction to unwind the other end side of the cold air film door 320 from the winding shaft 320b to decrease the air passage area of the rear cold air inlet 127j. Accordingly, the air passage area of the rear cold air inlet 127j is decreased in response to an increase in the air passage area of the rear hot air inlet 127i, and it is possible to raise the temperature of air blown off to the rear seat.

Then, in the maximum cooling state of the rear seat side, the hot air inlet 127i is fully closed by the hot air film door 310 and at the same time the rear cold air inlet 127j is fully opened by the cold air film door 320. Then, in the maximum heating state of the rear seat, the hot air inlet 127i is fully opened by the hot air film door 310 and at the same time the rear cold air inlet 127j is fully closed by the cold air film door 320.

Next, the operation effects of the fifth embodiment will be described with reference to FIG. 12. A horizontal axis in FIG. 12, just as with FIG. 10, designates the ratio of the door movement amount (door opening degree) of the rear temperature adjusting unit in a case where the maximum cooling position of the rear temperature adjusting unit is set at 0% and where the maximum heating position of the rear temperature adjusting unit is set at 100%. A vertical axis in FIG. 12 designates the ratio (%) of the air passage area of the rear hot air inlet 127i and the ratio (%) of the air passage area of the rear cold air inlet 127j. This ratio (%) of the air passage area means the ratio of the actual air passage area of the rear hot air inlet 127i or the rear cold air inlet 127j adjusted by the rear temperature adjusting unit to the maximum air passage area thereof (actual air passage area/maximum air passage area).

In FIG. 12, the solid line G1 shows a change in the air passage area of the rear hot air inlet 127i according to the fourth embodiment using the above-described butterfly-shaped two-plate doors 131, 132 in combination, and the solid line G2 shows a change in the air passage area of the rear hot air inlet 127i according to the fifth embodiment using the two film doors 310, 320 in combination, and the solid line G3 shows a change in the air passage area of the rear hot air inlet 127i according to a comparative example using the above-described usual single plate door.

Then, the broken line G4 shows a change in the air passage area of the rear cold air inlet 127j according to the fourth embodiment, and the broken line G5 shows a change in the air passage area of the rear cold air inlet 127j according to the fifth embodiment, and the broken line G6 shows a change in the air passage area of the rear cold air inlet 127j according to the comparative example.

As can be seen from the characteristics of the solid lines G1, G2 and the broken lines G4, G5, according to the fourth embodiment and the fifth embodiment, it is possible to nearly linearly vary the ratios of the air passage areas of the rear hot air inlet 127i and the rear cold air inlet 127j. Therefore, the ratios of the air passage areas vary nearly linearly with respect to the ratio of the door movement amount (door opening degree), as compared with the characteristics G3, G6 of the comparative example.

Comparing the fourth embodiment with the fifth embodiment, in the fifth embodiment, the film doors 310, 320 slides along the opening surfaces of the rear hot air inlet 127i and the rear cold air inlet 127j, so it is possible to make the ratio of the air passage area vary further linearly with respect to the door movement amount (door opening degree) in the fifth embodiment. Thus, it is possible to further improve linearity in a rear-blowing air temperature control in the fifth embodiment as compared with the fourth embodiment.

In the fifth embodiment, one ends 310a, 320a of the two film doors 310, 320 are fixed, and the other ends thereof are moved in the directions to come near to or to come away from this fixed one ends. However, it is also recommended that, similarly to the front air mixing door 19, a single film door having an opening for passing air can be used as the rear temperature adjusting unit. Even in this case, the air passage areas of the rear hot air inlet 127i and the rear cold air inlet 127j can be varied in a canceling manner by moving the opening of the single film door. Further, by using this single film door, the linearity in the rear-blowing air temperature control can be obtained similarly to the case where the film doors 310, 320 are used as in the fifth embodiment.

(Sixth Embodiment)

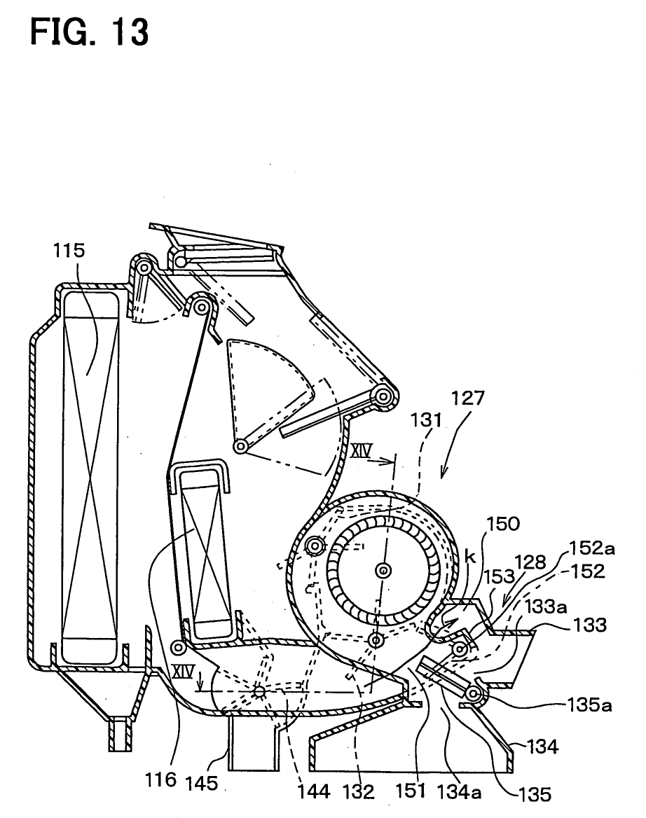

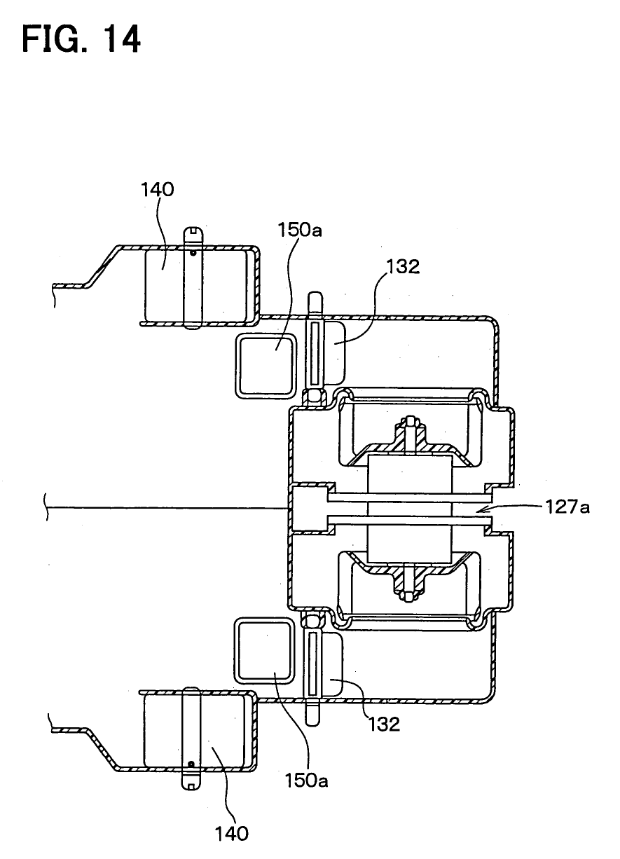

The sixth embodiment of the present invention will be now described with reference to FIGS. 13 and 14.

In the above-described fourth embodiment and the above-described fifth embodiment, hot air from the rear hot air inlets 127i and the cold air from the rear cold air inlets 127j are sucked in and sent to the rear air ducts 128 by the blower fans 127a, 127b of the rear sub-blower 127, so hot air is sufficiently mixed with and cold air while they are passed through the blower fans 127a, 127b. Thus, it is possible to send air having very little variations in temperature to the rear air ducts 128. However, in this case, when a bi-level mode is set as the rear air outlet mode, a temperature of air to be blown to the rear upper area is nearly equal to a temperature of air blown to the rear lower area in the passenger compartment. As a result, in the rear bi-level mode, a temperature difference between the upper-blowing air and the lower blowing air of the type of keeping passenger's head cool and feet warm can not be set. Therefore, the air-conditioning feeling in the bi-level mode for the rear seat area is deteriorated.

In view of the above problem, in the sixth embodiment of the present invention, a rear cold air bypass passage is formed so that it is possible to set a temperature difference between the upper-blowing air and the lower-blowing air of the type of keeping passenger's head cool and feet warm in the rear bi-level mode.

FIGS. 13, 14 show the sixth embodiment in which branching portions of cold air flowing through the rear cold air passage 118 are set in the upstream portions of the left and right rear cold air doors 132 (i.e., portions on the front side of the vehicle), and cold air introduction ports 150a (FIG. 14) of left and right rear cold air bypass passages 150 are arranged in the left and right branching portions.

Through the left and right rear cold air bypass passages 150, air can bypass the blower fans 127a, 127b of the rear sub-blower 127 and directly flows to the outlet sides of the scroll cases 127d, 127e. More specifically, the left and right rear cold air bypass passages 150, as shown by arrow “k” in FIG. 13, define air passages passing below the rear cold air doors 132 and the blower fans 127a, 127b and directly communicating with the rear face ducts 133 of the rear air ducts 128, that is, the portions downstream from the rear face opening 133a of the rear air ducts 128.

Here, FIG. 13 shows a cross-sectional position where the blower fans 127a, 127b are arranged in the lateral direction of the vehicle, so FIG. 13 can show only the outlet portions of the rear cold air bypass passages 150 and can not show the whole rear cold air bypass passages 150. In FIG. 13, the rear cold air bypass passages 150 are formed on the left and right sides in the lateral direction of the vehicle (i.e., in a direction vertical to the surface of paper) of outlet passages 151 of the scroll cases 127d, 127e (blower fans 127a, 127b).

A rear cold air bypass door 152 is arranged in the middle of the rear cold bypass passage 150 to open or close the rear cold bypass passage 150. The rear cold air bypass door 152, in this embodiment, is a plate door turning around the rotary shaft 152a, and the rotary shaft 152a is connected to a door operating mechanism made of an actuator mechanism using a servomotor to turn the rear cold air bypass door 152.

Next, the operation of the sixth embodiment will be now described. When a bi-level mode is set as the rear air outlet mode, the rear air outlet mode door 135, as shown in FIG. 13, is turned to a middle opening position where the rear face opening 133a and the rear foot opening 134a are opened at the same time.

By this operation of the rear air outlet mode door 135, conditioned air sent by the blower fans 127a, 127b of the rear sub-blower 127 can be branched into the rear face opening 133a and the rear foot opening 134a to introduce the conditioned air into both of the openings 133a, 134a at the same time.

Then, when the rear bi-level mode is set, the rear cold air bypass door 152 is turned to the open position of the rear cold air bypass passage 150. With this operation, a part of cold air at a position upstream of the rear cold air door 132 can be branched and introduced into the rear cold air bypass passage 150. This cold air bypasses the blower fans 127a, 127b of the rear sub-blower 127 by the rear cold air bypass passages 150 and directly flows into the rear face ducts 133 of the rear air ducts 128. Thus, conditioned air sent by the blower fans 127a, 127b and cold air from the rear cold air bypass passages 150 are joined in the rear face ducts 133. On the other hand, the cold air does not meet the conditioned air on the side of the rear foot opening 134a.

For this reason, the air temperature to be blown to the rear upper side of the passenger compartment can be lowered by the bypassed cold air as compared with the air temperature to be blown to the rear lower side of the passenger compartment. Thus, in the rear bi-level mode, it is possible to set a comfortable temperature difference between upper blowing air and lower blowing air, so that a temperature distribution of “cold head and warm feet” can be set. Thus, air-conditioning feeling in the rear bi-level mode can be improved.

Here, it is possible to easily adjust the temperature difference between upper blowing air and lower blowing air in the rear bi-level mode by adjusting the bypassing amount of cold air. That is, the air passage area of the rear cold air bypass passage 150 is adjusted by the rear cold air bypass door 152, so that the amount of cold air bypassing the mixing portion of the rear sub-blower 127 can be adjusted.

In this regard, in the sixth embodiment, it is very important to suitably set the joining position where conditioned air sent by the blower fans 127a, 127b (air passing the blower fan) is joined with cold air from the rear cold air bypass passage 150. This is, air passing the fan is naturally increased in pressure by the blower fans 127a, 127b. Therefore, a backward flow to the rear cold air bypass passage 150 may be caused if the joining portion is not suitably set.

Thus, in the sixth embodiment, the joining position is set on the back side of a seal wall surface 153 when the rear air outlet mode door 135 totally closes the rear face opening 133a on the outlet side of each of the scroll cases 127d, 127e. Since the air passing through the fan is prevented by this seal wall surface 153 from directly flowing to the back side of the seal wall surface 153, the back side of the seal wall surface 153 becomes a lower pressure portion where a vortex is formed. With this arrangement, it is possible to prevent the air passing through the fan from flowing backward to the rear cold air bypass passage 150, and hence it is possible to surely introduce cold air upstream of the rear cold air door 132 to the back side of the seal wall surface 150 through the rear cold air bypass passage 150.

(Seventh Embodiment)

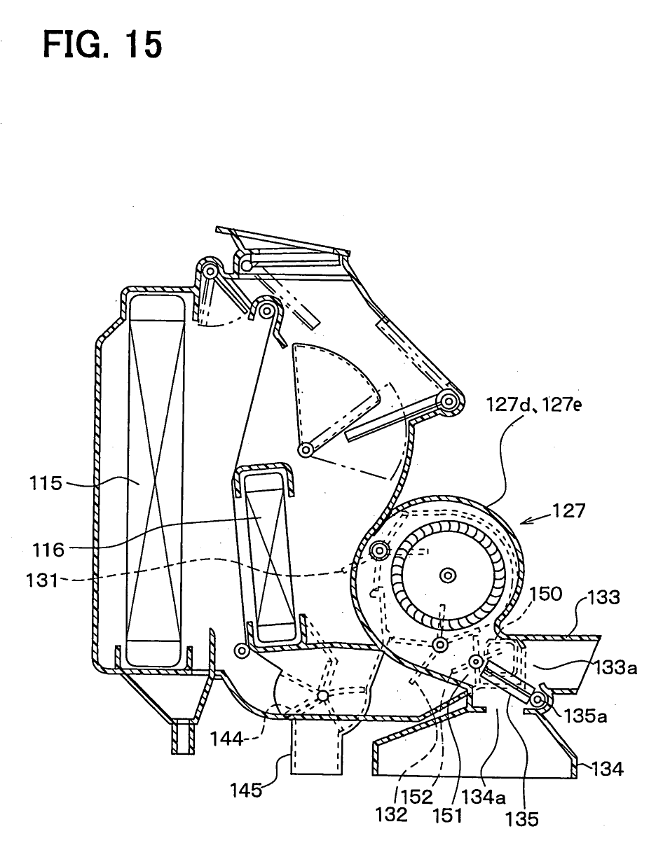

The seventh embodiment of the present invention will be now described with reference to FIG. 15.

In the above-described sixth embodiment of the present invention, the joining portion where air sent by blower fans 127a, 127b (i.e., air passing through the fans) is joined with cold air from the rear cold air bypass passage 150 is set on the back of the seal wall surface 153 of the rear air outlet mode door 135. In the seventh embodiment, however, as shown in FIG. 15, openings are formed in portions directly before the rear face ducts 133 (face openings 133a) of the left and right side walls of the outlet passages 151 of the scroll cases 127d, 127e (blower fans 127a, 127b), and the outlets of the rear cold air bypass passages 150 are made to communicate with these openings formed in the left and right side walls of the outlet passages 151.

The outlet passages 151 of the scroll cases 127d, 127e are passage portions where the air velocity (dynamic pressure) of air sent by the blower fans 127a, 127b is increased. Thus, if the outlets of the rear cold air bypass passages 150 are made to communicate with the left and right side walls of the passage portions where the air velocity is increased, the influent of pressure drop caused by the increased air velocity reaches the outlets of the rear cold air bypass passages 150. With this, cold air from the rear cold air bypass passages 150 can be introduced into the portion directly before the rear face ducts 133 of the outlet passages 151.

In the sixth and seventh embodiments, in the rear bi-level mode, a part of cold air upstream of the rear cold air doors 132 bypasses the rear sub-blower 127 by the rear cold air bypass passages 150 and directly flow into the rear face ducts 133 of the rear air ducts 128, so that there is produced a temperature difference between the upper blowing air and the lower blowing air. However, it is also recommended that in place of the rear cold air bypass passages 150, rear hot air bypass passages (not shown) are provided so that a part of hot air upstream of the rear hot air doors 131 bypasses the rear sub-blower 127 by the rear hot air bypass passages and directly flow into the rear foot ducts 134 of the rear air ducts 128. Even in this case, it is possible to produce the temperature difference between the upper blowing air, and the temperature distribution of the “cool head and warm feet” can be set in the rear bi-level mode.

Also in this case, by providing the rear hot air bypass passages with rear hot air bypass doors capable of adjusting the air passage areas, it is possible to adjust the temperature difference between the upper blowing air and the lower blowing air in the rear bi-level mode by adjusting the opening degrees of the rear hot air bypass doors.

In this regard, the rear cold air bypass doors 152 and the rear hot air bypass doors can be made of opening/closing valves for only simply opening or closing the rear cold air bypass passages 150 or the rear hot air bypass passages by designing the air passage areas of the rear cold air bypass passages or the rear hot air bypass passages to be suitable air passage areas in advance by experiments. The suitable air passage areas are air passage areas for setting the temperature difference between the upper blowing air and the lower blowing air at a suitable value.

(Other Embodiments)

Although the present invention has been fully described in connection with the preferred embodiments thereof with reference to the accompanying drawings, it is to be noted that various changes and modifications will become apparent to those skilled in the art.

For example, in the first embodiment, there is described regarding the example in which the hot air doors 31 are operated by the rear hot air operating mechanism and the cold air doors 32 are operated by the rear cold air operating mechanism, independently from the hot air doors 31. However, it is possible to operate the hot air doors 31 and the cold air doors 32 by using a single common rear temperature adjusting mechanism, if there is provided a link mechanism which can compatibly set a door operation state where the hot air doors 31 and the cold air doors 32 are fully closed at the same time to set the rear shut state, and a door operation state where both of the hot air doors 31 and the cold air doors 32 are operated between a fully closed side and to a fully open side in a canceling manner in synchronization with each other so as to control a rear-blowing air temperature.

Further, if the rear shut state can be set by the rear air outlet mode doors 35 in the first embodiment, it is possible to operate all of the four hot air doors 31 and the four cold air doors 32 in synchronization with each other by the single common rear temperature adjusting mechanism.

Further, if the rear shut state can be set by the rear air outlet mode doors 35 in the first embodiment, it is possible to adjust the ratio of hot air volume and cold air volume on the rear seat side by the use of one air mixing door 47, similarly to the case with the third embodiment, without arranging the hot doors 31 and the cold air doors 32 separately as the rear hot air adjusting unit.

In the above-described embodiments, the air conditioning devices provided with the rear temperature adjusting unit have been described. However, the present invention can be applied to an air conditioning device having no rear temperature adjusting unit. That is, a part of conditioned air whose temperature is adjusted by the front temperature adjusting unit can be branched and can be increased in pressure by the rear sub-blower 27 and is sent to the rear seats.

Still further, examples in which both of the front area and the rear area in the passenger compartment are air-conditioned by the front air conditioning unit have been described in the above described first to third embodiments. However, air flow resistance in the seat side air passage is increased as compared with the front air passage also in a case where the front area and the passenger's seats in the passenger compartment are air-conditioned by the front air conditioning unit. In this case, a sub-blower 27 exclusive to the seat side air passage may be provided to produce the same operation effect. Still further, it is also recommended to apply the present invention to a case where conditioned air is sent to both of the front area and the passenger's seats in the passenger compartment by the sub-blower 27.

Still further, it is also recommended to arrange face air outlet ports each provided with an air outlet grille capable of adjusting the direction of air in the upper portions of the center pillars of the vehicle (i.e., B pillar between the front door and the rear door of the vehicle), and to introduce conditioned air from the front air conditioning unit into the face air outlet ports arranged in the center pillars via the rear face ducts 36 by the sub-blower 27 to blow off conditioned air mainly to the rear area from these face air outlet ports. Here, by providing the face air outlet ports in the center pillars with the grille mechanisms capable of adjusting the direction of air, it is possible to blow conditioned air from the face air outlet ports in the center pillars toward the front area of the present compartment.

In the above-described embodiments, examples in which various kinds of operating mechanisms are constructed of actuator mechanisms are described. However, these operating mechanisms can be constructed of manual operating mechanisms if necessary.

Still further, examples in which the sub-blower 127 and the rear air ducts 128 are integrated with the case 114 have been described in the fourth to seventh embodiments, but the present invention can be applied also to a case where the rear air ducts are separated from the case 114 and is formed on the side of the rear air ducts 136, 137 and where the rear sub-blower 127 is provided at the rear air ducts 128 separated from the case 114.

In the fourth to seventh embodiments, air flow resistance in the seat side air passage becomes very large as compared with the front air passage also in a case where the front area and the passenger's seats in the passenger compartment are air-conditioned by the front air conditioning unit. Thus, it is also recommended to provide the sub-blower 27 to produce the same operation effect.

Still further, the front air conditioning unit of the front/rear independent control type capable of controlling the temperature of air blown off to the front area and the rear area in the passenger compartment independently from each other has been described in the above the fourth to seventh embodiments. However, if in the case 114 of the heat exchange unit 2 of the front air conditioning unit, the air passage downstream of the evaporator 115 is partitioned into an air passage on the right side of the vehicle (i.e., driver's seat side air passage in a right-hand drive vehicle) and an air passage on the left side of the vehicle (i.e., passenger's seat side air passage in the right-hand drive vehicle) and a front right temperature adjusting unit and a front left temperature adjusting unit are provided as a front temperature adjusting unit 119 in such a manner as to be operated independently from each other and a rear right temperature adjusting unit and a rear left temperature adjusting unit are provided as rear temperature adjusting units 131, 132, 310, 320 in such a manner as to be operated independently from each other, it is possible to independently control the air temperatures blown toward four areas of front/rear and left/right areas in the passenger compartment. In this case, by providing the left and right driving motors 127c of the left and right blower fans 127a, 127b of the sub-blower 127 independently from each other and by controlling the numbers of revolutions of the left and right driving motors 127c independently from each other, it is possible to independently control the volume of air blown off to the rear right area and the volume of air blown off to the left area.

Such changes and modifications are to be understood as being within the scope of the present invention as defined by the appended claims.

What is claimed is:

1. An air conditioner for a vehicle having a passenger compartment, the air conditioner comprising:
a main blower for blowing air;
a heat exchange unit for performing heat exchange with air blown by the main blower;
a case for accommodating the heat exchange unit, the case having a first passage through which conditioned air after being heat-exchanged with the heat exchange unit flows toward a first area in the passenger compartment, and a second passage through which conditioned air after being heat-exchanged in the heat exchange unit flows toward a second area in the passenger compartment;
a connection duct through which conditioned air in the second passage is introduced to the second area of the passenger compartment, the connection duct being connected to the second passage such that an air flow resistance in the second passage becomes larger than an air flow resistance in the first passage; and
a sub-blower disposed integrally with the case, for blowing conditioned air in the second passage toward the second area of the passenger compartment.

2. The air conditioner according to claim 1, wherein:
the heat exchange unit includes at least a heating heat exchanger for heating air; and
the second passage includes a hot air passage through which air after passing through the heating heat exchanger flows, and a cold air passage through which air bypassing the heating heat exchanger flows, the air conditioner further comprising
a temperature adjustment unit disposed to adjust an air amount flowing through the hot air passage and an air amount flowing through the cold air passage to adjust a temperature of the conditioned air to be blown to the second area in the passenger compartment,
wherein the sub-blower is disposed downstream of the temperature adjustment unit.

3. The air conditioner according to claim 1, wherein:
the cold air passage is provided at a lower side of the heating heat exchanger;
the hot air passage is provided at an upper side of the cold air passage; and
the sub-blower is disposed at a lower side portion in the case.

4. The air conditioner according to claim 1, wherein:
the heat exchange unit includes at least a heating heat unit for heating air;
the sub-blower is disposed directly downstream of the heating heat exchanger at a lower side portion in the case.

5. The air conditioner according to claim 1, wherein the sub-blower is constructed with a centrifugal blower fan and a driving motor for driving the centrifugal blower fan.

6. The air conditioner according to claim 5, wherein:
the driving motor is a double shaft type having two rotary shafts protruding to two sides in an axial direction; and
the blower fan includes two centrifugal fans disposed at the two outsides of the rotary shafts in the axial direction to be connected to rotary shafts.

7. The air conditioner according to claim 5, wherein:
the blower fan is arranged such that its axial direction is in a vehicle right-left direction;
the driving motor is arranged at an outer peripheral side of the blower fan; and
the sub-blower further includes a rotation transmission unit through which a rotation of the driving motor is transmitted to the blower fan.

8. The air conditioner according to claim 1, wherein the sub-blower is constructed with a cross flow fan and a driving motor for driving the cross flow fan.

9. The air conditioner according to claim 1, wherein:
the first area is a front seat area in the passenger compartment;
the first air passage is a front air passage through which air flows toward the front seat area;
the second area is a rear seat area in the passenger compartment; and
the second air passage is a rear air passage through which air flows toward the rear seat area.

10. The air conditioner according to claim 9, further comprising:
a front temperature adjustment unit that adjusts temperature of air blown from the front air passage; and
a rear temperature adjustment unit that adjusts temperature of air blown from the rear air passage, wherein:
the heat exchange unit includes at least a heating heat exchanger for heating air;
the rear temperature adjustment unit is disposed to adjust a flow ratio between hot air after passing through the heating heat exchanger and cold air bypassing the heating heat exchanger, in the rear air passage; and
the sub-blower is disposed at a downstream side of the rear temperature adjustment unit in the rear air passage.

11. The air conditioner according to claim 1, wherein:
the rear air passage includes a rear hot air passage through which air after passing through the heating heat exchanger flows, and a rear cold air passage through which air bypassing the heating heat exchanger flows;
the rear temperature adjustment unit includes a rear hot air door for adjusting a passage area of the rear hot air passage, and a rear cold air door for adjusting a passage area of the rear cold air passage;
in a maximum heating state of the rear seat area, the rear hot air door fully opens the rear hot air passage, and the rear cold air door fully closes the rear cold air passage;
in a maximum cooling state of the rear seat area, the rear hot air door fully closes the rear hot air passage, and the rear cold air door fully opens the rear cold air passage; and
in a temperature adjustment state of the rear seat area between the maximum heating state and the maximum cooling state, one of the rear hot air door and the rear cold air door is operated to increase the passage area, and the other one of the rear hot air door and the rear cold air door is operated to decrease the passage area.

12. The air conditioner according to claim 11, wherein the rear hot air door and the rear cold air door are disposed to set a rear shut state where the rear hot air door fully closes the rear hot air passage and the rear cold air door fully closes the rear cold air passage.

13. The air conditioner according to claim 11, wherein the rear hot air door and the rear cold air door are arranged at a side of a suction port of the sub-blower in an axial direction of the sub-blower.

14. The air conditioner according to claim 13, wherein:
each of the rear hot air door and the rear cold air door is a plate door rotatable in a rotation space; and
the rear hot air door and the rear cold air door are disposed such that its rotation spaces are positioned at an inner peripheral side of the suction port.

15. The air conditioner according to claim 13, wherein the rear hot air door and the rear cold air door are film doors moved along opening surfaces of the rear hot air passage and the rear cold air passage.

16. The air conditioner according to claim 10, wherein:
the heating heat exchanger is disposed in the case to form a rear cold air passage at a lower side of the heating heat exchanger, and a front cold air passage at an upper side of the heating heat exchanger; and
the front temperature adjustment unit is disposed to adjust a flow ratio between air passing through the heating heat exchanger in the front air passage and air passing through the front cold air passage.

17. The air conditioner according to claim 10, wherein the case further has therein a seat cold air passage into which air branched from the rear cold air passage flows, and a seat hot air passage into which air after passing through the heating heat exchanger flows, the air conditioner further comprising
a seat temperature adjustment unit for adjusting a flow ratio between air from the seat hot air passage and air from the seat cold air passage to adjust a temperature of conditioned air to be blown into a seat in the passenger compartment.

18. The air conditioner according to claim 17, wherein:
the rear hot air passage, the rear cold air passage and the rear temperature adjustment unit are provided in a center area of the case in a vehicle right left direction; and
the seat cold air passage, the seat hot air passage and the seat temperature adjustment unit are provided at right and left outsides of the rear warm air passage, the rear cold air passage and the rear temperature adjustment unit in the vehicle right-left direction.

19. The air conditioner according to claim 10, wherein:
the rear air passage is branched downstream of the sub-blower, into a rear face passage through which air is blown toward a rear upper side in the rear seat area of the passenger compartment, and a rear foot passage through which air is blown toward a rear lower side in the rear seat area of the passenger compartment; and
the rear air passage includes a rear bypass passage through which a part of air at an upstream portion upstream from the rear temperature adjustment unit is directly introduced into any one of rear face passage and the rear foot passage.

20. The air conditioner according to claim 19, further comprising
a rear bypass door that changes a passage area of the rear bypass passage.

21. The air conditioner according to claim 19, wherein the rear bypass passage has an outlet portion that is joined to a pressure reducing portion in which an air pressure is reduced due to an air flow of the sub-blower.

22. The air conditioner according to claim 19, wherein the rear bypass passage is a rear cold air bypass passage through which a part of cold air in the rear cold air passage at the upstream portion of the rear temperature adjustment unit is directly introduced to the rear face passage.

23. The air conditioner according to claim 19, wherein the rear bypass passage is a rear hot air bypass passage through which a part of hot air in the rear hot air passage at the upstream portion of the rear temperature adjustment unit is directly introduced to the rear foot passage.
